(19) United States
(12) Patent Application Publication
(10) Pub. No.: US 2025/0118839 A1
(43) Pub. Date: Apr. 10, 2025

(54) BATTERY ASSEMBLY

(71) Applicant: Generac Power Systems, Inc., Waukesha, WI (US)

(72) Inventors: Peter Lex, Waukesha, WI (US); Charles Heyrman, Dousman, WI (US); David Oteman, Delafield, WI (US); Evan Malone, Denver, CO (US)

(73) Assignee: Generac Power Systems, Inc., Waukesha, WI (US)

(21) Appl. No.: 18/947,988

(22) Filed: Nov. 14, 2024

Related U.S. Application Data
(63) Continuation of application No. PCT/US2024/050552, filed on Oct. 9, 2024.
(60) Provisional application No. 63/588,977, filed on Oct. 9, 2023.

(51) Int. Cl. H01M 50/209; H01M 10/658; H01M 50/251

(52) U.S. Cl. CPC H01M 50/209; H01M 10/658; H01M 50/251

(57) ABSTRACT

A battery module assembly includes a first battery cell and a second battery cell. The first battery cell includes a rear surface, a side surface, and a top surface. A second battery cell also includes a front surface, a side surface, and a top surface. The front surface of the second battery cell contacts the rear surface first battery cell. A barrier contacts the side surfaces of both the first battery cell and the second battery cell.

### CROSS-REFERENCE TO RELATED APPLICATION

This application is a continuation of International App. No. PCT/US2024/050552, filed on Oct. 9, 2024, which claims the benefit of and priority to U.S. Application No. 63/588,977, filed on Oct. 9, 2023, the disclosures of which are hereby incorporated by reference in their entireties.

### BACKGROUND

Prismatic battery assemblies refer to the arrangement and integration of prismatic battery cells into a larger battery pack or system. These assemblies are commonly used in various applications, such as, for example, electric vehicles (EVs), consumer electronics, and renewable energy storage systems.

Prismatic battery cells are typically rectangular or square in shape and can vary in size. They contain the electrochemical components necessary for storing and discharging electrical energy. Prismatic battery assemblies may include multiple prismatic battery cells.

### SUMMARY

In general terms, this disclosure is directed to a battery assembly. In some embodiments, and by non-limiting example, the battery assembly includes a first battery cell and a second battery cell. The first battery cell and the second battery cell are arranged such that the front face of the second battery cell is adjacent to the rear face of the first battery cell. A barrier is arranged adjacent to the side face of the first and the second battery cells.

One aspect of the present disclosure includes a battery module assembly comprising a first battery stack. The first battery stack comprises a first battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface. The first battery stack further comprises a first battery stack second battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface. The front surface of the first battery stack first battery cell is arranged parallel to the front surface of the first battery stack second battery cell, the top surface of the first battery stack first battery cell is arranged coplanar with the top surface of the first battery stack second battery cell, and the side surface of the first battery stack first battery cell is arranged coplanar with the side surface of the first battery stack second battery cell. The battery module assembly further includes a barrier having a first surface and a second surface, the first surface of the barrier being arranged parallel and adjacent to the side surface of the first battery stack first battery cell and the side surface of the first battery pack second battery cell.

Another aspect of the present disclosure includes an energy storage system. The energy storage system comprises a cabinet comprising a front surface and a rear surface, the rear surface being configured to be mounted to a wall of a building. The energy storage system further comprises a battery module assembly housed within the cabinet. The battery module assembly includes a first battery stack comprising a first battery stack first battery cell and a first battery stack second battery cell. The first battery stack first battery cell and the first battery stack second battery cell contact each other at a first seam. The battery module assembly further includes a second battery stack comprising a second battery stack first battery cell and a second battery stack second battery cell. The second battery stack first battery cell and the second battery stack second battery cell contact each other at a second seam. The first seam is arranged in a first seam plane and the second seam is arranged in a second seam plane. The first seam plane and the second seam plane are co-planar with each other.

Another aspect of the present disclosure includes an energy storage system. The energy storage system comprises a cabinet and a battery module assembly housed within the cabinet. The battery module assembly includes a first battery stack comprising a first battery stack first battery cell and a first battery stack second battery cell. The first battery stack first battery cell and the first battery stack second battery cell contact each other at a first seam. The first seam is arranged in a plane that is parallel to the plane of a front surface of the cabinet.

### BRIEF DESCRIPTION OF THE DRAWINGS

FIG. 1 is a front schematic view of an example energy storage system.

FIG. 2 is a top schematic view of the energy storage system of FIG. 1.

FIG. 3 is a perspective view of example battery module assembly.

FIG. 4 is an exploded perspective view of the battery module assembly of FIG. 3.

FIG. 5 is another perspective view of the example battery module assembly of FIG. 3.

FIG. 6 is an exploded perspective view of an example housing.

FIG. 7 is a perspective view of an example bottom panel and thermal sheet.

FIG. 8 is a perspective view of the bottom panel of FIG. 7.

FIG. 9 is another perspective view of the bottom panel of FIG. 7.

FIG. 10 is a perspective view of an example front panel.

FIG. 11 is another perspective view of the front panel of FIG. 10.

FIG. 12 is a perspective view of an example rear panel.

FIG. 13 is another perspective view of the rear panel of FIG. 12.

FIG. 14 is a perspective view of an example top panel.

FIG. 15 is a perspective view of an example right panel.

FIG. 16 is a perspective view of an example left panel.

FIG. 17 is a right section view of the housing of FIG. 6.

FIG. 18 is a top section view of the housing of FIG. 6.

FIG. 19 is a front section view of the housing of FIG. 6.

FIG. 20 is a perspective view of an example battery portion and control portion.

FIG. 21 is an exploded perspective view of the battery portion of FIG. 20.

FIG. 22 is a perspective view of an example barrier.

FIG. 23 is a perspective view of an example battery cell.

FIG. 24 is a perspective view of an example battery stack.

FIG. 25 is a perspective view of an example battery pack.

FIG. 26 is an exploded perspective view of a portion of the battery pack of FIG. 25.

FIG. 27 is a perspective view of an example bus assembly.

FIG. 28 is a perspective view of an example frame.

FIG. 29 is a perspective view of an example board and bus contacts.

FIG. 30 is another perspective view of the bus assembly of FIG. 27.

FIG. 31 is a top view of the battery module assembly of FIG. 3.

FIG. 32 is a top view of the battery module assembly of FIG. 3 with the top panel and portions of the bus assembly removed.

FIG. 33 is a perspective view of an example control portion.

FIG. 34 is a perspective view of an example rear plate.

FIG. 35 is a schematic view of portions of the battery module assembly of FIG. 3.

FIG. 36 is an exploded perspective view of portions of the battery module assembly of FIG. 3.

FIG. 37 is a schematic view of portions of another example battery module assembly.

FIG. 38 is a flowchart illustrating an example method of manufacturing the battery module assembly of FIG. 3.

FIG. 39 is a front schematic view of an example energy storage system.

FIG. 40 is a perspective view of the example battery module assembly.

FIG. 41 is a partially exploded perspective view of an example housing of the battery module assembly of FIG. 40.

FIG. 42 is a top perspective view of the example bottom panel of the housing of FIG. 41.

FIG. 43 is front perspective view of the front panel of the housing of FIG. 41 with fasteners extending therethrough.

FIG. 44 is a bottom perspective view of the top panel of the housing of FIG. 41.

FIG. 45 is a bottom perspective view of the top panel of the housing of FIG. 41.

FIG. 46 is a left perspective view of the example right panel of the housing of FIG. 41.

FIG. 47 is a right perspective view of the left panel of the housing of FIG. 41.

FIG. 48 is a top perspective view of an example intermediate panel of the housing of FIG. 41.

FIG. 49 is a perspective view of an example PCB backing panel of the housing of FIG. 41.

FIG. 50 is a right section view of the housing of FIG. 41.

FIG. 51 is a top sectional view of the housing of FIG. 41.

FIG. 52 is a rear section view of the housing of FIG. 41.

FIG. 53 is a perspective view of an example battery portion and an example control portion of the battery module assembly of FIG. 40.

FIG. 54 is an exploded perspective view of the battery portion of FIG. 53.

FIG. 55 is a perspective view of an example battery grid and the intermediate panels of the battery module assembly of FIG. 40.

FIG. 56 is a perspective view of an example major bus assembly of the battery portion of FIG. 53.

FIG. 57 is a perspective view of an example control portion of the battery module assembly of FIG. 53.

FIG. 58 is a top view of portions of the battery module assembly illustrating the compression profile of the battery portion of FIG. 53.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

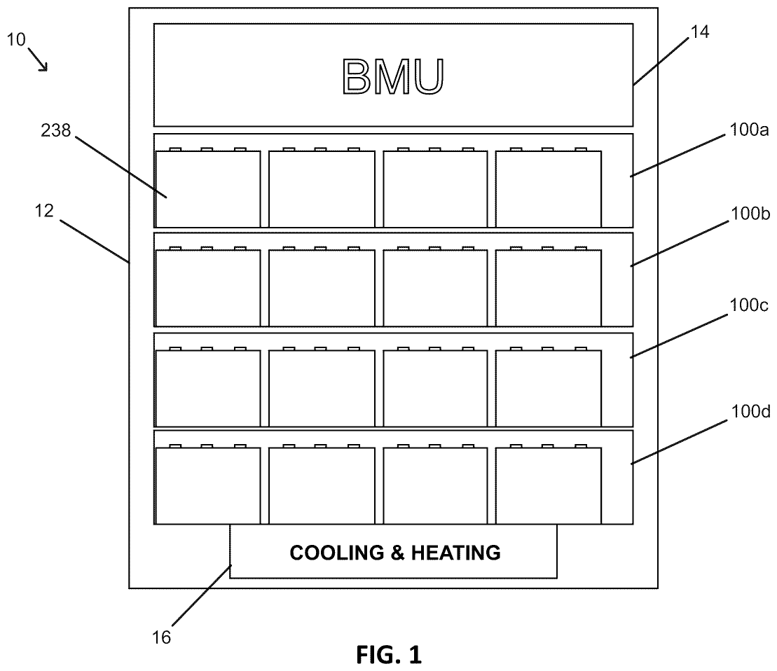

FIG. 1 is a front schematic view of an example energy storage system 10. In some examples, the energy storage system 10 may be used for a variety of applications, such as, for example, residential applications including renewable energy storage, emergency backups, or electric vehicle charging. In some examples, the energy storage system 10 is used for industrial applications such as utilities and grid storage, uninterruptible power supplies, emergency backups or lighting or telecommunications.

In some examples, the energy storage system 10 includes a cabinet 12, a battery management unit 14, a thermal unit 16, and one or more battery module assemblies 100a, 100b, 100c, 100d.

In some examples, the cabinet 12 houses the components of the energy storage system 10. The cabinet 12 protects the components from environmental conditions outside of the cabinet 12. In some examples, the cabinet 12 is configured to be mounted to a wall.

In some examples, the battery management unit 14 is arranged within the cabinet 12 and is configured to perform system monitoring and control of the energy storage system. In some examples, the battery management unit 14 performs voltage monitoring, current monitoring, temperature monitoring, cell balancing, charge control, discharge control, and communication, fault diagnosis, state of charge estimation, emergency shutdown, and/or any other number of similar functions.

In some examples, the thermal unit 16 is also located within the cabinet 12 and performs functions such as heating and cooling of the battery module assemblies 100a, 100b, 100c, 100d.

In some examples, the battery module assemblies 100a, 100b, 100c, 100d are arranged within the cabinet 12, such as, for example, horizontally along the width of the cabinet 12. In some examples, as described in greater detail herein, the battery module assemblies 100a, 100b, 100c, 100d each include a plurality of battery cells 238. In some examples, the battery cells 238 are oriented within the cabinet 12 such that the terminals of the battery cells 238 are arranged upwardly with respect to the ground when the cabinet 12 is installed (e.g. mounted to a wall or placed on the ground). In some examples, as shown in FIG. 1, the energy storage system 10 includes four battery module assemblies 100a, 100b, 100c, 100d. each of which are stacked on top of one another. In some examples, the cabinet 12 includes greater or fewer battery module assemblies 100a, 100b, 100c, 100d.

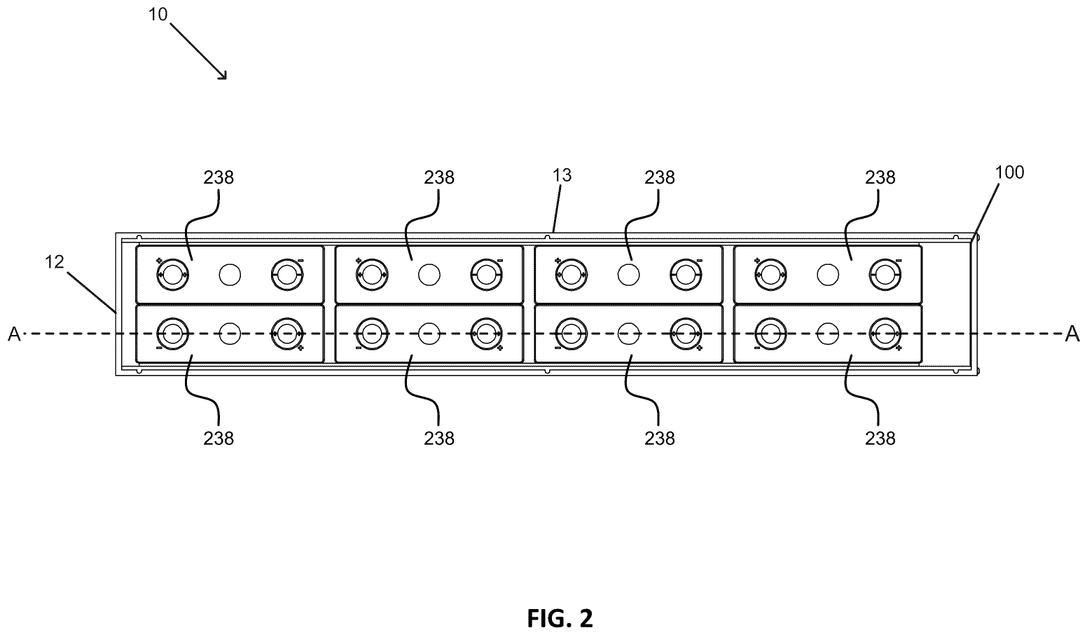

FIG. 2 is a top sectional view of certain components of the energy storage system 10. In some examples, the cabinet 12 of the energy storage system includes a front face 13. In some examples, each of the battery cells 238 includes a longitudinal axis L that extends along the length of the battery cell 238. In some examples, the longitudinal axis L extends parallel to the front face 13 of the cabinet 12.

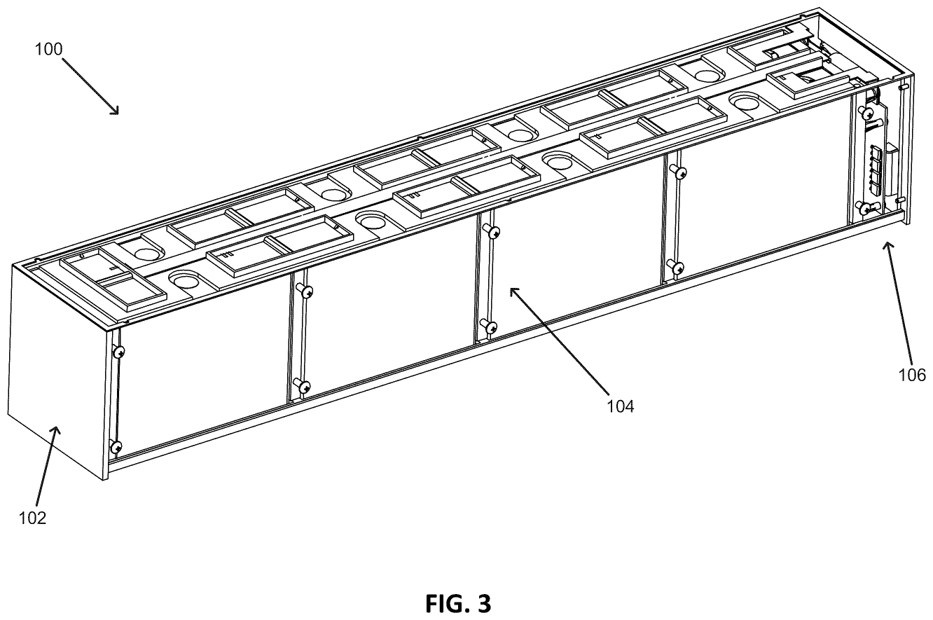

FIG. 3 is perspective view of certain portions of an example battery module assembly 100. In the example of FIG. 3, the battery module assembly 100 includes a housing 102, a battery portion 104, and a control portion 106.

In some examples, the housing 102 contains the battery portion 104. The housing 102 includes an interior space in which the battery portion 104 is arranged. In some examples, the housing 102 further contains the control portion 106. In some examples, the housing 102 functions to protect the components arranged therein. In other examples, the housing 102 functions to provide compression to components contained therein. The battery portion 104 functions to store energy within the battery module assembly 100. In some examples, the battery portion 104 is arranged within the housing 102 and adjacent to the control portion 106. The control portion 106 functions to provide a power connection port and fuses for the battery cell portion. In some examples, the control portion 106 is a battery management system.

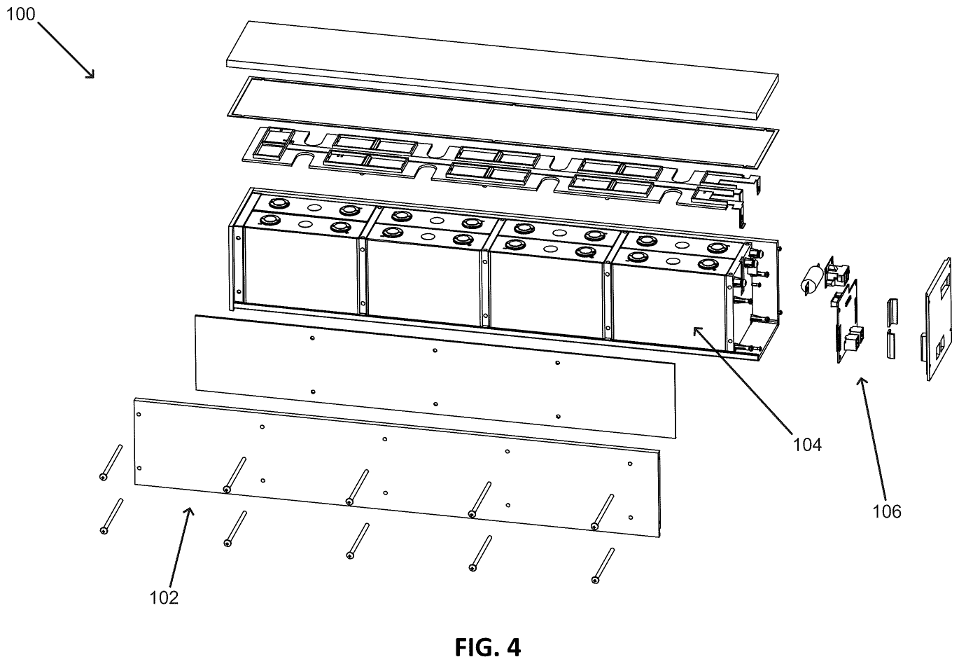

FIG. 4 is an exploded perspective view of the battery module assembly 100. As shown in FIG. 3, the housing 102 contains the battery portion 104 and the control portion 106 therewithin. In some examples, the housing 102 includes various panels and components which may be assembled together to seal the battery portion 104 or disassembled to expose the battery portion 104.

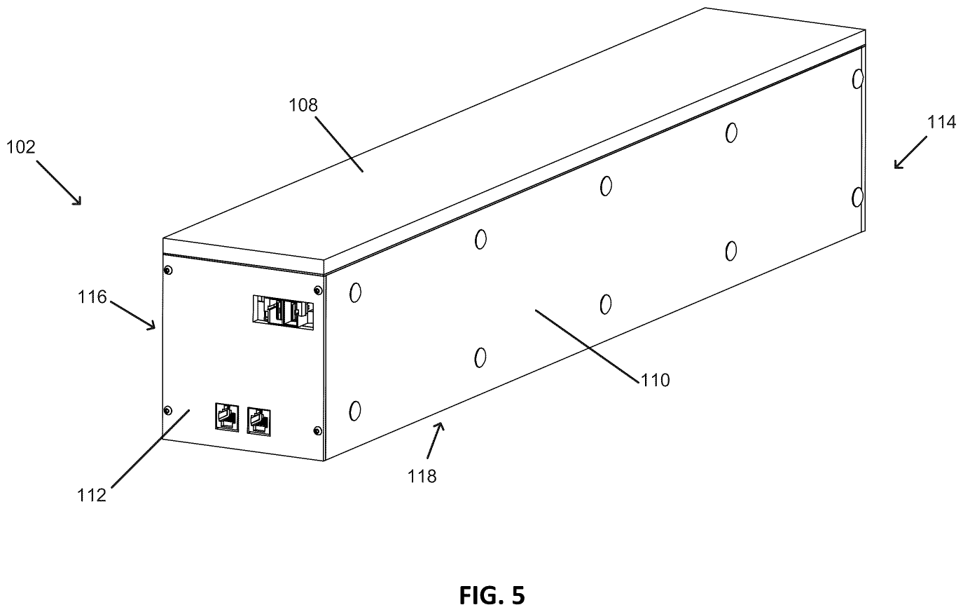

FIG. 5 is a perspective view of an example housing 102. In some examples, the housing includes a top panel 108, a front panel 110, a right panel 112, a left panel 114, a rear panel 116, and a bottom panel 118. In some examples, each of the top panel 108, a front panel 110, a right panel 112, a left panel 114, a rear panel 116, and a bottom panel 118 fit together to form a rectangular housing. In some examples, each of the top panel 108, a front panel 110, a right panel 112, a left panel 114, a rear panel 116, and a bottom panel 118 are formed from a material with high structural strength and integrity, such as for example, a polymer material, a plastic material, and/or a metal material such as steel or aluminum.

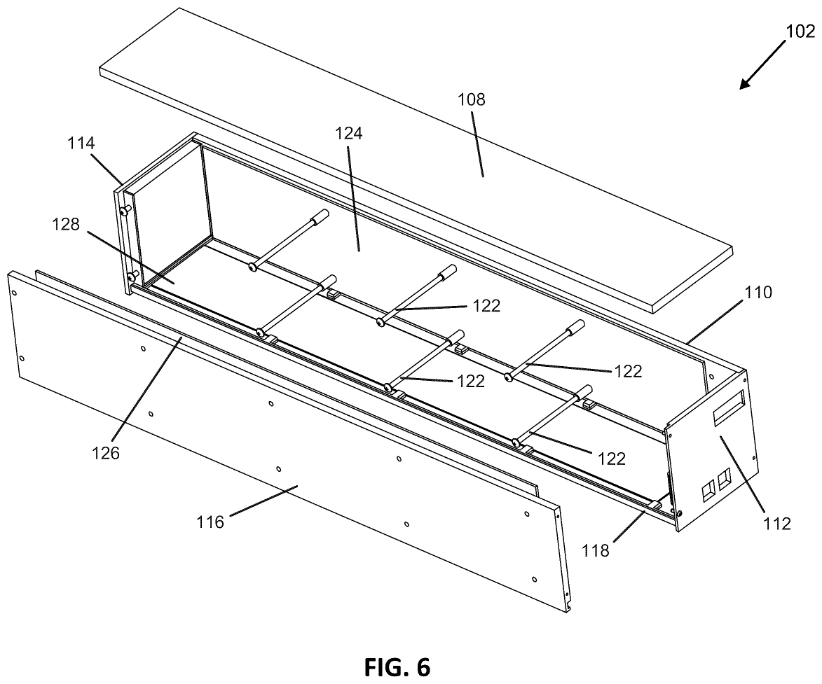

FIG. 6 is an exploded view of the example housing 102. As shown in the example of FIG. 6, in some examples, the housing 102 further includes a front lining sheet 124, a rear lining sheet 126, and a thermal sheet 128. In some examples, the front lining sheet 124 and the rear lining sheet 126 provide cushion to the contents of the housing 102 from the front panel 110 and the rear panel 116. In some examples, the front lining sheet 124 is arranged parallel to the front panel 110 and abuts the front panel 110. In some examples, the rear lining sheet 126 is arranged parallel to the rear panel 116 and abuts the rear panel 116. In some examples, the thermal sheet 128 is arranged parallel to the bottom panel 118 and abuts the bottom panel 118. In some examples, the thermal sheet 128 is a heating pad. In other examples, the thermal sheet 128 is a cooling pad. In some examples, the thermal sheet 128 is a three-line harness powered by the battery portion 104 and controlled by the control portion 106. In some examples, the front lining sheet 124 and the rear lining sheet 126 also are thermal sheets that function substantially similarly to the thermal sheet 128. In some examples, the housing 102 includes an additional thermal sheet that is arranged parallel to the top panel 108 and abuts the top panel 108.

In some examples, the example housing 102 further includes one or more fasteners 122 that extend therethrough. In some examples, the fasteners 122 function to fasten the front panel 110 to the rear panel 116. In some examples, the fasteners 122 include threads and function to tighten the front panel 110 against the rear panel 116 as to compress the battery portion 104 arranged within the housing 102. In some examples, the fasteners 122 comprise a male portion and a female portion. In some examples, the male portions extend through holes in the rear panel 116 and the female portions extend through holes in the front panel 110 or vice versa. In other examples, the female portions can be formed within the front panel 110 or the rear plate. The male portions extend through the interior of the housing 102 and extend into the female portions, at which point they can be threaded into the female portions to secure the front panel 110 to the rear panel 116. In some examples, the front panel 110 and the rear panel 116 can be drawn closer together by screwing the male portions of the fasteners 122 into the female portions of the fasteners 122. In some examples, the front panel 110 and the rear panel 116 exhibit a clamping force on the battery portion 104 when the front panel 110 and the rear panel 116 are drawn together. In some examples, the clamping force is a recommended clamping force provided by the manufacturer of the battery cells 238. In some examples, the clamping force is controlled by applying a specified torque to each of the fasteners 122.

In some examples, the front panel 110 and the rear panel 116 include recesses within which heads of the fasteners 122 may be arranged. In such examples, the heads of the fasteners 122 do not protrude out from the outer surface of the front panel 110 and the rear panel 116.

In some examples, using the front panel 110 and the rear panel 116 to provide compression to the battery portion 104 is beneficial because the front panel 110 and the rear panel 116 increases the contact area on the battery cells 238 allowing for a more even distribution of the contact force on the battery cells 238. In some examples, the compliance of the front panel 110 and the rear panel 116 help to provide a more even distribution of the contact force on the battery cells 238.

In other examples, the fasteners 122 do not include threads. In such examples, the front panel 110 and the rear panel 116 are drawn together using a fixture during assembly of the battery module assembly 100 to provide a desired clamping force to the battery portion 104 between the front panel 110 and the rear panel 116. In such examples, after the front panel 110 and the rear panel 116 are drawn together, the front panel 110 and the rear panel 116 are fixed together. In some examples, the front panel 110 and the rear panel 116 are fixed together through welding, such as, for example laser welding fasteners 122 together.

In other examples, the front panel 110 and the rear panel 116 are held together without the use of fasteners 122. In such examples, the front panel 110 and the rear panel are fixed together using, for example, bands, clamps, or fixtures. In some examples, the panels of the housing 102 are laser welded directly to each other such that the front panel 110 and the rear panel 116 are maintained at a fixed position relative to each other.

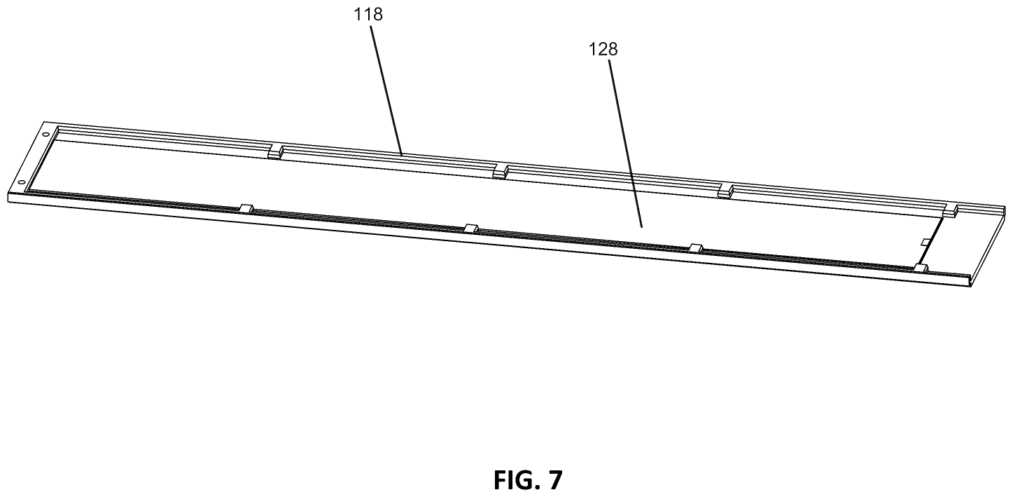

FIG. 7 is a top perspective view of the bottom panel 118 and the thermal sheet 128 of the housing. In some examples, the thermal sheet 128 is adhesively attached to the bottom panel 118. In other examples, the thermal sheet 128 is merely placed onto the surface of the bottom panel 118 when the housing 102 is assembled. In some examples, the thermal sheet 128 covers the entire surface of the bottom panel 118. In other examples, the thermal sheet 128 covers only the portion of the bottom panel 118 upon which the battery portion 104 is arranged when the battery portion 104 is arranged within the housing 102. In some examples, the thermal sheet 128 is centered on the bottom panel 118 so that a portion of the bottom panel 118 extends out from each side of the thermal sheet 128 and is uncovered by the thermal sheet 128.

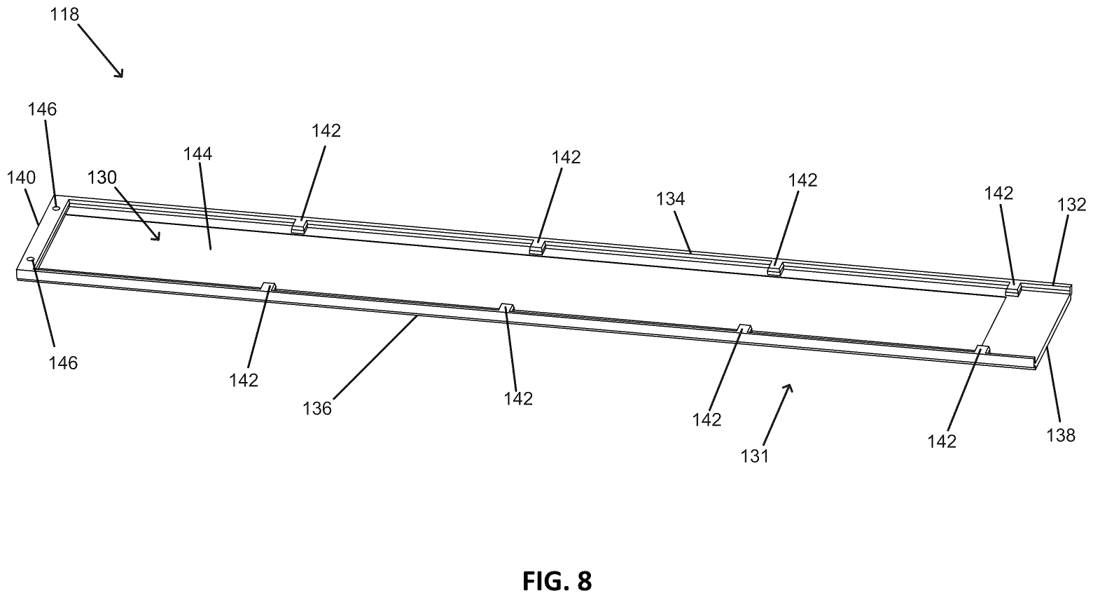

FIG. 8 is a top perspective view of the bottom panel 118. As shown in the example of FIG. 8, the bottom panel 118 includes a top surface 130, a bottom surface 131, a front side 134, a rear side 136, a right side 138, a left side 140, one or more flanges 132, one or more lips 142, and a recess 144.

In some examples, the bottom panel 118 includes flanges 132 extending around the top surface 130. In some examples, the flanges 132 extend upwardly from the top surface 130 around the entire perimeter of the bottom panel 118. In some examples, the flanges 132 interface with the front panel 110, the right panel 112, the left panel 114, and the rear panel 116 to seal the housing 102. In some examples, the flange includes holes 146 into which fasteners extend to fasten the bottom panel 118 to the rest of the housing 102.

In some examples, the lips 142 are also arranged on the top surface 130 of the bottom panel 118 and extend over the top surface 130 of the bottom panel 118 from the flanges 132. In some examples, the lips 142 only extend from the portions of the flanges 132 that extend along the front side 134 and the rear side 136 of the bottom panel 118.

In some examples, the recess 144 is formed on the top surface 130 of the bottom panel 118. In some examples, the recess 144 extends substantially across the entirety of the top surface 130 of the bottom panel 118. In some examples, the recess 144 does not extend over any portion of the top surface 130 on which any of the lips 142 are arranged. In some examples, the recess 144 only extends over the portion of the top surface 130 of the bottom panel 118 on which the thermal sheet 128 is arranged.

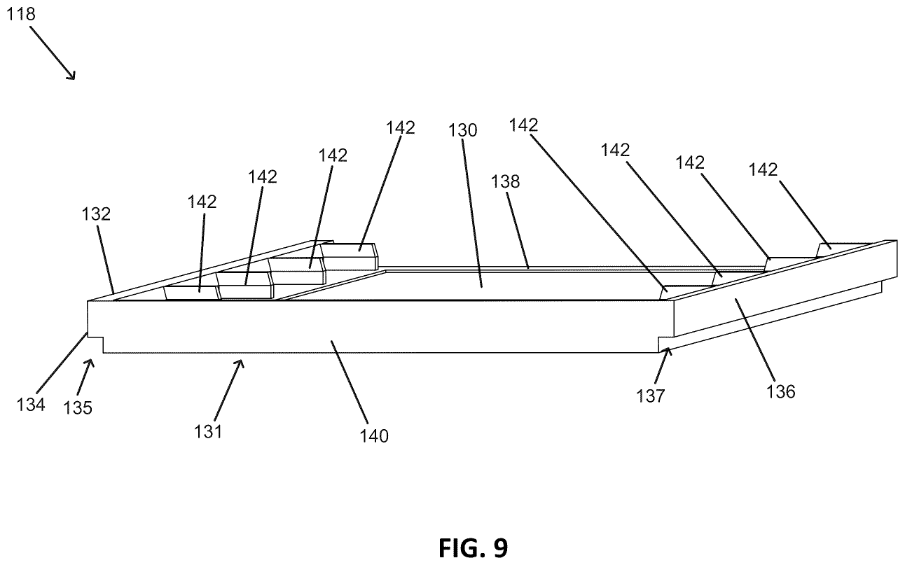

FIG. 9 is a left perspective view of the bottom panel 118. As shown in FIG. 9, the bottom panel 118 further includes a front notch 135 and a rear notch 137. In some examples, the front notch 135 is arranged along the front side 134 of the bottom panel 118 and extends along the front side 134 of the bottom panel 118 through the bottom surface 131 of the bottom panel 118, the left side 140 of the bottom panel 118, and the right side 138 of the bottom panel 118. Likewise, in some examples, the rear notch 137 is arranged along the rear side 136 of the bottom panel 118 and extends along the rear side 136 of the bottom panel 118 through the bottom surface 131 of the bottom panel, the left side 140 of the bottom panel, and the right side 138 of the bottom panel 118. In some examples, each of the front notch 135 and the rear notch 137 are rectangularly shaped.

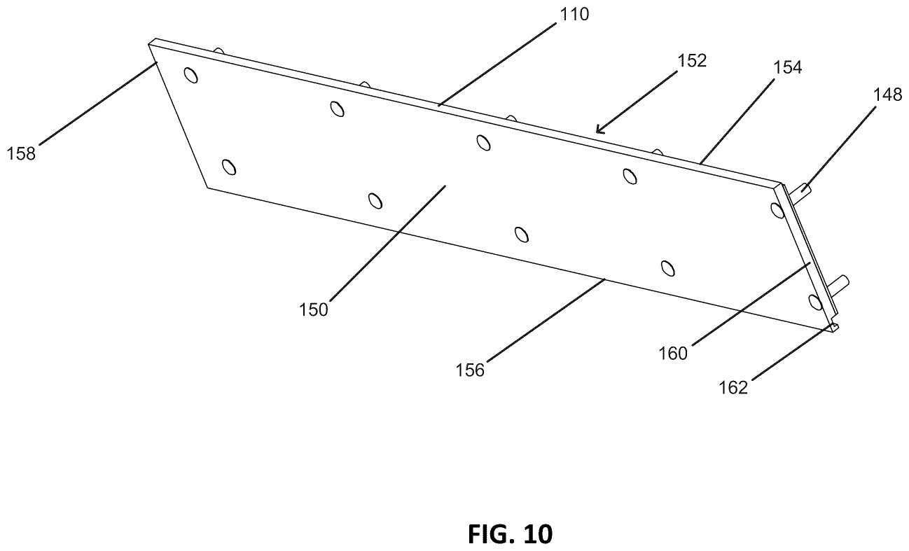

FIG. 10 is a front perspective view of the front panel 110 with female portions 148 of the fasteners 122 arranged thereon. In some examples, the front panel 110 includes an outer surface 150, an inner surface 152, a top side 154, a bottom side 156, a right side 158, a left side 160 and a notch 162.

In some examples, the female portions 148 of the fasteners 122 extend through holes machined through the outer surface 150 and the inner surface 152 of the front panel 110. In other examples, the female portions 148 are formed with the front panel 110. In some examples, the female portions 148 include tapped holes into which the male portions of the fasteners extend and engage with.

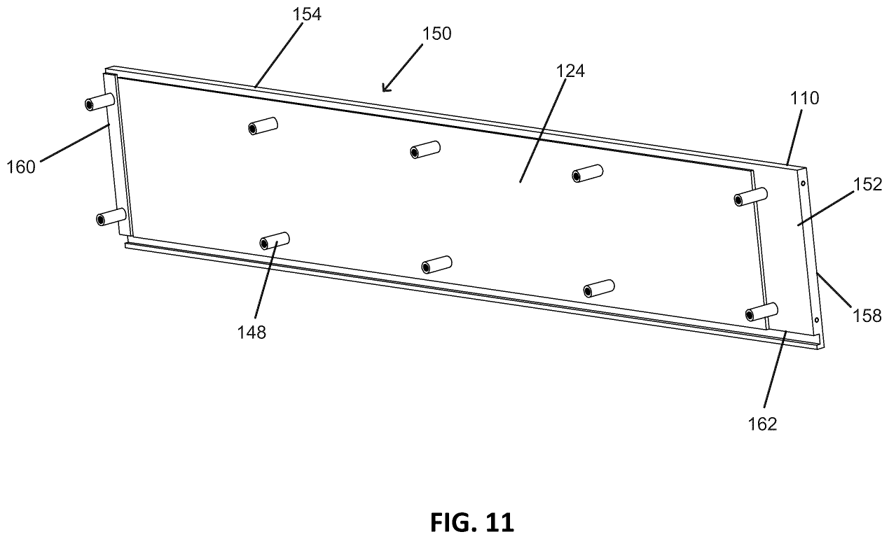

FIG. 11 is a rear perspective view of the front panel 110 and the front lining sheet 124 with the female portions 148 of the fasteners 122 arranged thereon. As shown in FIG. 10, in some examples, the front lining sheet 124 is arranged on the front panel 110 such that it partially covers the inner surface 152 of the front panel 110. In some examples, a portion of the right side of the inner surface 152 remains uncovered by the front lining sheet 124. In some examples, the front lining sheet 124 includes holes arranged thereon such that the female portions 148 extend through the front lining sheet 124 when the front lining sheet 124 is arranged over the inner surface 152 of the front panel 110. As shown in FIG. 10, the notch 162 is formed in the inner surface 152 of the front panel 110. In some examples, the notch 162 extends along the bottom end of the inner surface 152 of the front panel 110 from the right side 158 to the left side 160 of the front panel 110. In some examples, the notch 162 extends through the right side 158 and the left side 160 of the front panel.

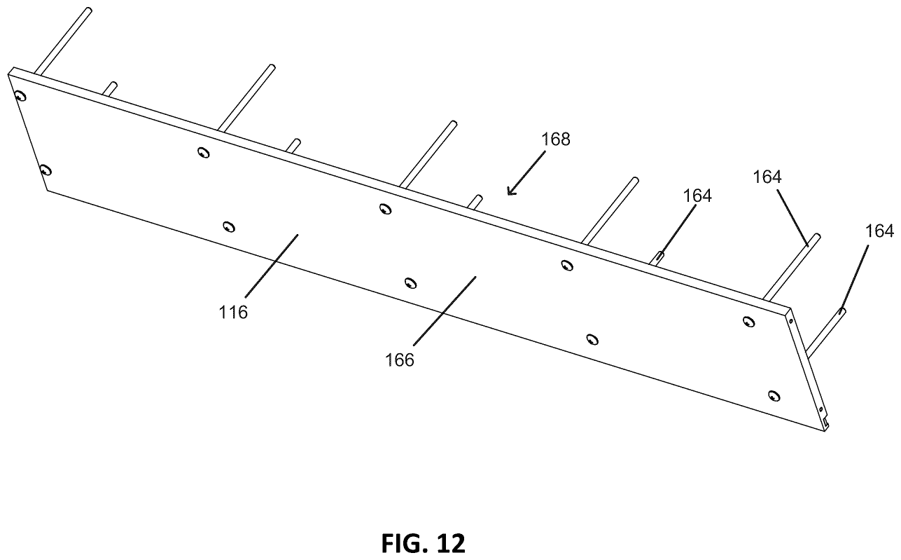

FIG. 12 is a rear perspective view of the rear panel 116 with male portions 164 of the fasteners 122 arranged thereon. In some examples, the rear panel 116 is formed substantially similarly to the front panel 110. In some examples, the rear panel includes an outer surface 166 and an inner surface 168. In some examples, the male portions 164 of the fasteners 122 extend through the rear panel 116 via holes that are formed in the rear panel 116.

In some examples, the male portions 164 extend through the rear panel 116 through holes machined through the outer surface 166 and the inner surface 168 of the rear panel 116. In other examples, the male portions 164 are formed with the rear panel 116. In some examples, the male portions 164 include threads arranged on the outer surface of the male portions which engage with the female portions 148 of the fasteners 122.

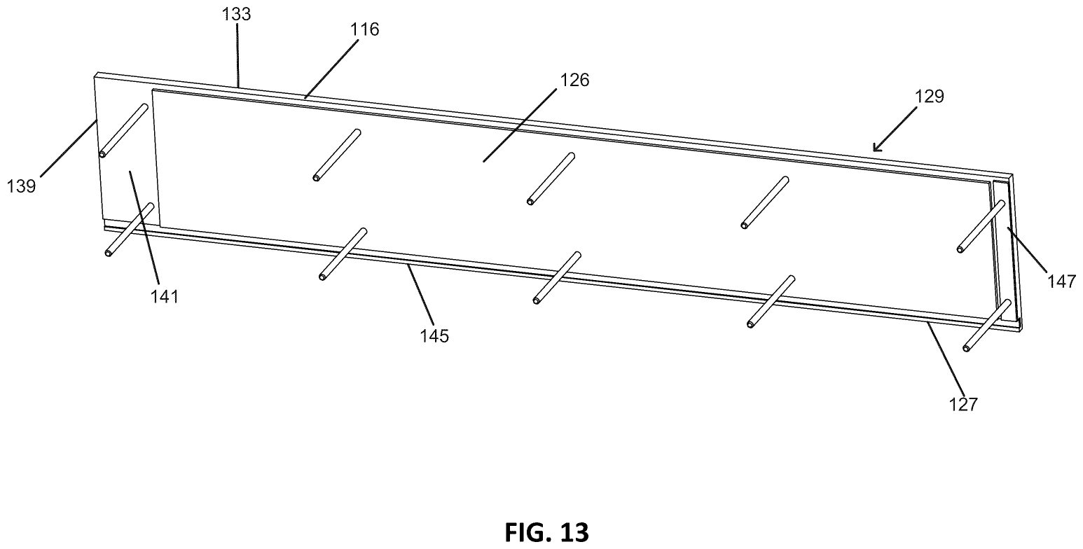

FIG. 13 is a front perspective view of the rear panel 116 and the rear lining sheet 126 with the male portions 164 arranged thereon. In some examples, the rear panel 116 and the rear lining sheet 126 are substantially similar to the front panel 110 and the front lining sheet 124. For example, in some examples, the rear panel 116 includes an outer surface 129, an inner surface 141, a top side 133, a bottom side 145, a left side 147, a right side 139, and a notch 127 formed thereon.

While the male portions 164 are described as being arranged on the rear panel 116 and the female portions 148 are described as being arranged on the front panel 110, in alternative embodiments, the male portions 164 are arranged on the front panel 110 and the female portions 148 are arranged on the rear panel 116.

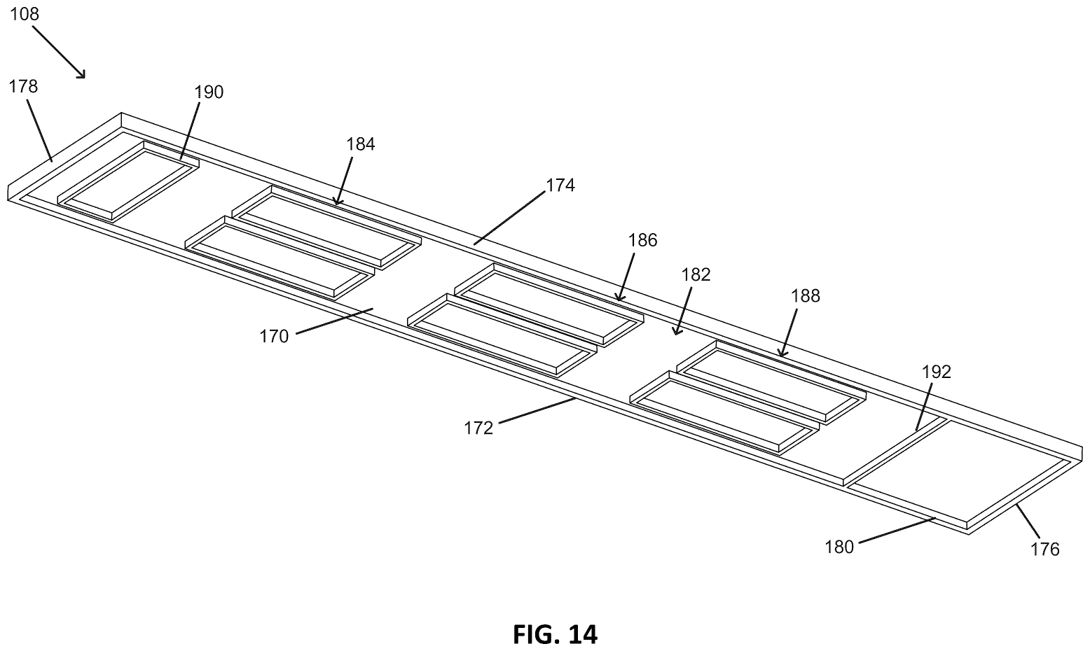

FIG. 14 is a bottom perspective view of the top panel 108. In some examples, the top panel 108 includes a bottom surface 170, a front surface 172, a rear surface 174, a right surface 176, a left surface 178, an outer flange 180, and one or more inner flanges 182.

In some examples, the outer flange 180 extends around the perimeter of the top panel 108 along the front surface 172, rear surface 174, right surface 176, and left surface 178. In some examples, the outer flange 180 extends down from the bottom surface 170 of the top panel 108.

In some examples, the one or more inner flanges 182 include a first rectangular pair 184, a second rectangular pair 186, a third rectangular pair 188, a transverse rectangle 190, and a transverse flange 192, each of which extend downward from the bottom surface 170 of the panel. In some examples, the first rectangular pair 184, second rectangular pair 186, and third rectangular pair 188 each include a rectangular pair of flanges that are oriented such that each of the lengths of the rectangles of the rectangular pairs are arranged next to each other with one of the rectangles of the rectangular pair being arranged in front of the other one of the rectangles of the rectangular pair. In some examples, each of the rectangles of the rectangular pairs includes a longitudinal axis that extends between the right surface 176 to the left surface 178 of the top panel 108. In some examples, the second rectangular pair 186 is arranged between the first rectangular pair 184 and the third rectangular pair 188 such that it is arranged to the right of the first rectangular pair 184 and to the left of the third rectangular pair 188.

In some examples, the transverse rectangle 190 is arranged such that the longitudinal axis of the transverse rectangle 190 is oriented perpendicularly to the longitudinal axis of each of the rectangles of the first rectangular pair 184, second rectangular pair 186, and third rectangular pair 188. In some examples, the transverse rectangle 190 is arranged between the first rectangular pair 184 and the left surface 178 of the top panel 108.

In some examples, the transverse flange 192 extends between and contacts a portion of the outer flange 180 extending along the front surface 172 and a portion of the outer flange 180 extending along the rear surface 174. In some examples, the transverse flange 192 is arranged between the third rectangular pair 188 and the right surface 176 of the top panel 108.

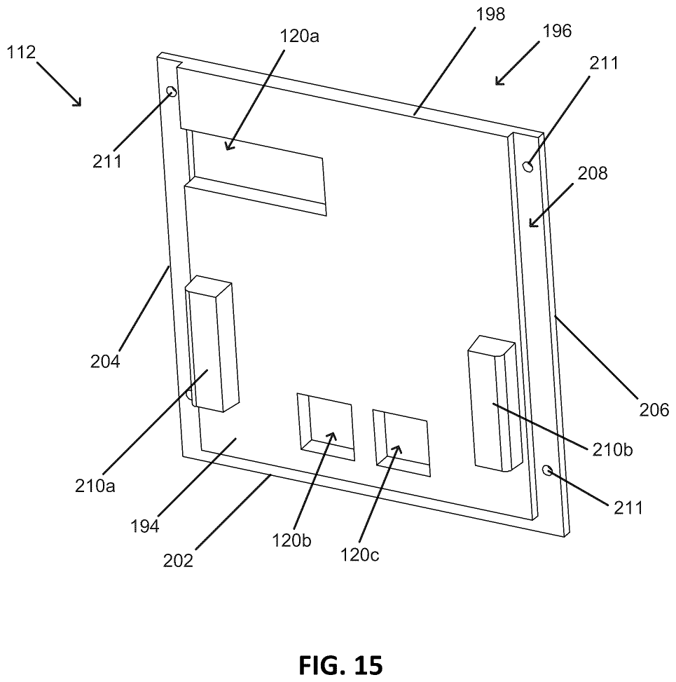

FIG. 15 is a left perspective view of the right panel 112. In the example of FIG. 15, the right panel 112 includes one or more recesses 120, an inner surface 194, an outer surface 196, a top side 198, a bottom side 202, a front side 204, a rear side 206, an outer notch 208, one or more inwardly extending protrusions 210, and one or more holes 211.

In some examples, the recesses 120 allow access to the interior of the housing 102. In some examples, the one or more recesses 120 includes a first recess 120a, a second recess 120b, and a third recess 120c. In some examples, the recesses 120 extends through the inner surface 194 and the outer surface 196 of the right panel 112.

In some examples, outer notch 208 is formed on the inner surface 194 of the right panel 112. In some examples, the outer notch 208 extends along the front side 204, the bottom side 202, and the rear side 206. In some examples, the outer notch 208 does not extend along the top side 198 but the portions of the outer notch 208 along the rear side 206 and the front side 204 extend through the top side 198.

In some examples, the inwardly extending protrusions 210 extend out from the inner surface 194. In some examples the inwardly extending protrusions comprise a first inwardly extending protrusion 210 arranged along the front side 204 of the right panel 112 and a second inwardly extending protrusion 210 arranged along the rear side 206 of the right panel 112.

In some examples, the holes 211 extend through the right panel 112 within the region of the outer notch 208 from the outer surface 196 through the inner surface 194. In some examples, fasteners extend through the holes 211 to secure the right panel 112 to the front panel 110 or the rear panel 116.

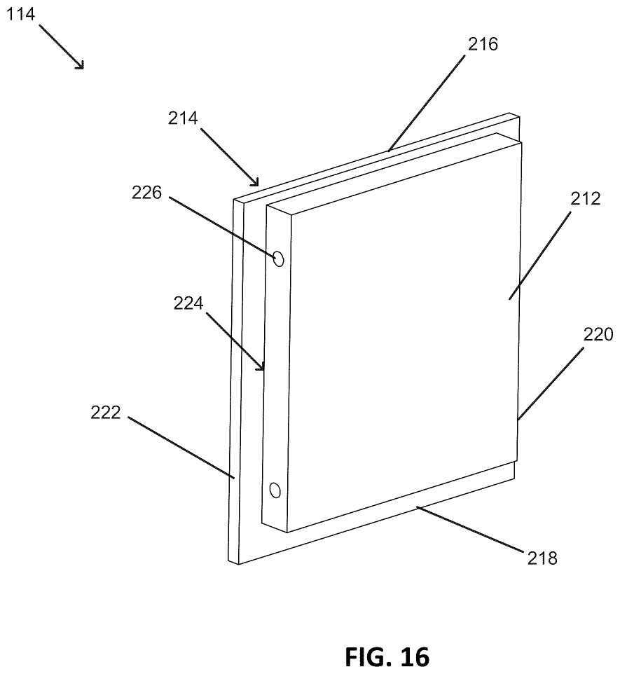

FIG. 16 is a right perspective view of the left panel 114. In some examples, the left panel 114 includes an inner surface 212, an outer surface 214, a top side 216, a bottom side 218, a front side 220, a rear side 222, an outer notch 224, and one or more holes 226.

In the example of FIG. 16 the outer notch 224 extends around the outer perimeter of the left panel 114 along the top side 216, bottom side 218, front side 220, and the rear side 222. In some examples, the outer notch extends through the inner surface 212 of the left panel 114. In some examples, the holes 226 extend through the front side 220 of the left panel 114 through the rear side 222 of the left panel within the region of the outer notch 224. In some examples, fasteners extend into the holes 226 to secure the left panel 114 in place.

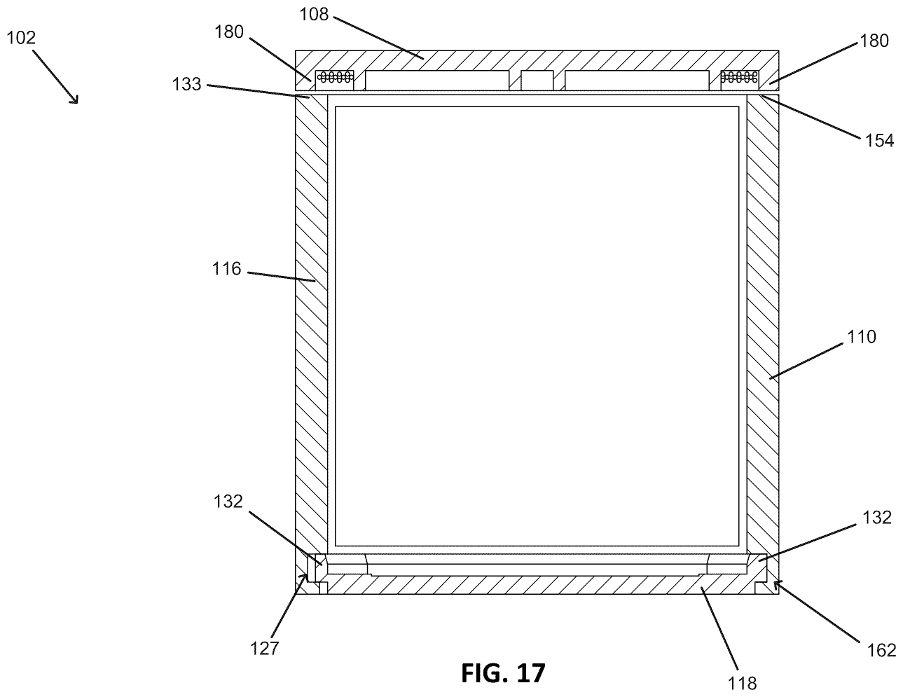

FIG. 17 is a right section view of the housing 102. As shown in FIG. 17, the front panel 110 and the rear panel 116 each engage with the bottom panel 118 to secure the bottom panel 118 to the housing 102. Specifically, the outer flange on the bottom panel 118 is received within the notch 162 of the front panel 110 and the notch 127 of the rear panel 116. In some examples, as shown in FIG. 17, the bottom panel 118 is sized slightly smaller than the width between the front panel 110 and the rear panel 116 such that there is a gap between the front side 134 of the bottom panel 118 and the front panel 110 and the rear side 136 of the bottom panel and the rear panel 116. The gap permits the bottom panel 118 to move by a predetermined amount in a forwardly and rearwardly direction with respect to the front panel 110 and the rear panel 116.

In some examples, the top panel 108 is arranged above the top side 154 of the front panel 110 and the top side 133 of the rear panel 116. In some examples, the outer flange 180 of the top panel 108 rests on the top side 154 of the front panel 110 and the top side 133 of the rear panel 116.

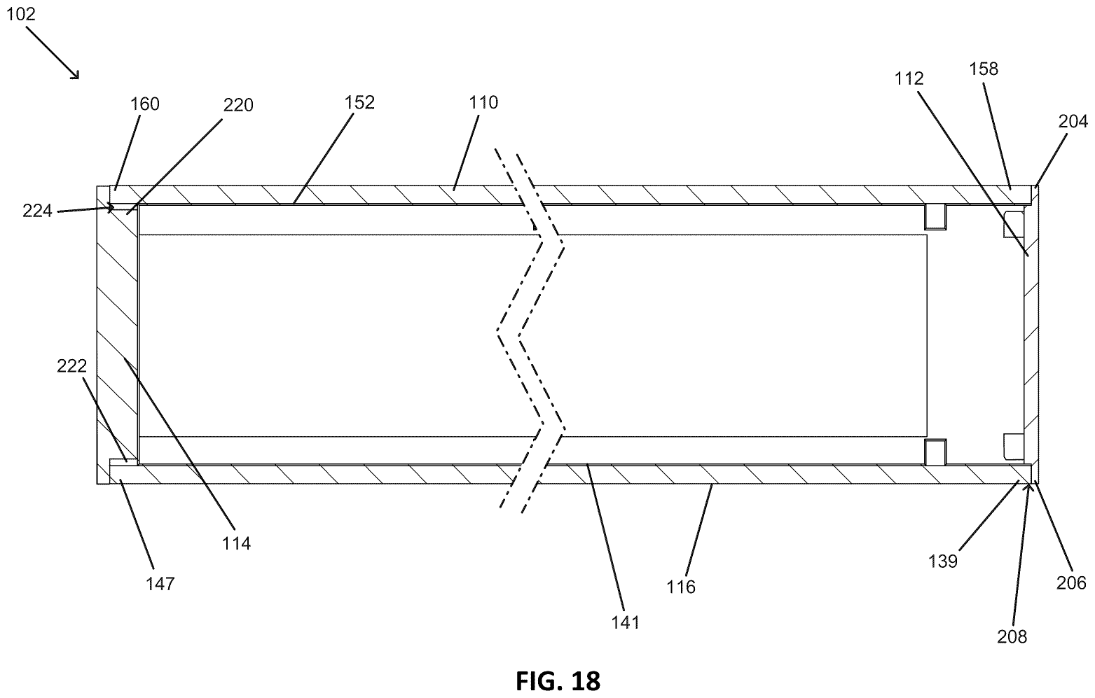

FIG. 18 is a top section view of the housing 102. As shown in FIG. 18, the front panel 110 and the rear panel 116 each engage with the left panel 114 and the right panel 112. Specifically, the left side 160 of the front panel 110 is received within the outer notch 224 of the left panel 114. Likewise, the left side 147 of the rear panel 116 is received within the outer notch 224 of the left panel 114.

Furthermore, the right side 158 of the front panel 110 is received within the outer notch 208 of the right panel 112. Likewise, the right side 139 of the rear panel 116 is received within the outer notch 208 of the right panel 112.

In some examples, as shown in FIG. 18, the left panel 114 is sized slightly smaller than the width between the front panel 110 and the rear panel 116 such that there is a gap between the portion of the front side 220 of the left panel 114 that abuts the inner surface 152 of the front panel 110 and that there is a gap between the portion of the rear side 222 of the left panel 114 that abuts the inner surface 141 of the rear panel 116.

Similarly, In some examples, the right panel 112 is sized slightly smaller than the width between the front panel 110 and the rear panel 116 such that there is a gap between the portion of the front side 204 of the right panel 112 that abuts the inner surface 152 of the front panel 110 and that there is a gap between the portion of the rear side 206 of the right panel 112 that abuts the inner surface 141 of the rear panel 116.

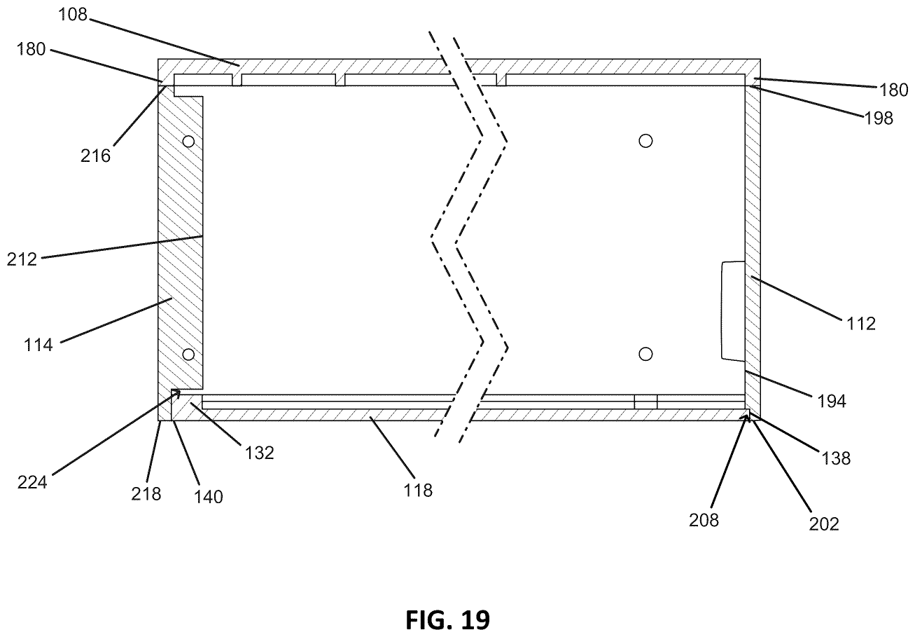

FIG. 19 is a front section view of the housing 102. As shown in FIG. 19, the housing 102 is configured such that the left side 140 of the bottom panel 118 abuts the inner surface 212 of the left panel 114. In some examples, the upper surface of the flange 132 at the left side of the bottom panel 118 also abuts the bottom side 218 of the left panel 114. Thus, in some examples, a portion of the bottom panel 118 is received by the outer notch 224 of the left panel 114. In some examples, the top side 216 of the left panel 114 contacts the bottom surface 170 of the top panel 108. In some examples, the top side 216 of the left panel 114 contacts the outer flange 180 of the top panel 108.

In some examples, the right side 138 of the bottom panel 118 contacts the inner surface 194 of the right panel 112. In some examples, a portion of the upper surface of the bottom panel 118 contacts a portion of the bottom side 202 of the right panel 112. Thus, in some examples, a portion of the bottom panel 118 is received by the outer notch 208 of the right panel 112. In some examples, the top side 198 of the right panel 112 contacts the bottom surface 170 of the top panel 108. In some examples, the top side 198 of the right panel 112 contacts the outer flange 180 of the top panel 108.

In some examples, the housing 102 includes one or more gaskets that are arranged between the surfaces of the panels that contact one another. In some examples, the gaskets seal the interior of the housing 102 from the external environment of the housing.

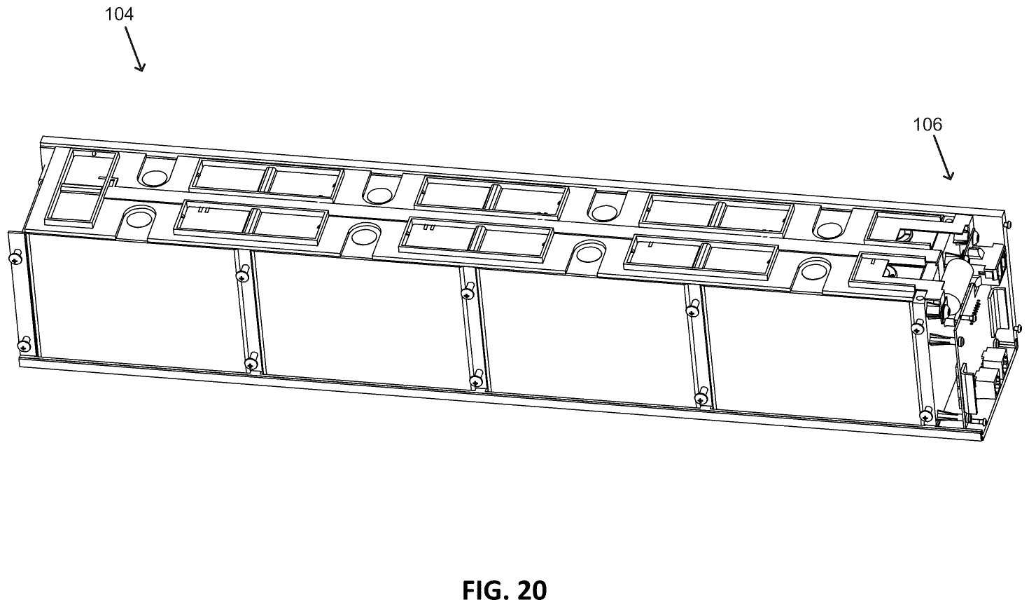

FIG. 20 is a perspective view of the battery portion 104 and the control portion 106 of the battery module assembly 100. As shown in FIG. 20, in some examples, the control portion 106 is arranged immediately adjacent to the battery portion 104. In some examples, the control portion 106 abuts a side of the battery portion 104.

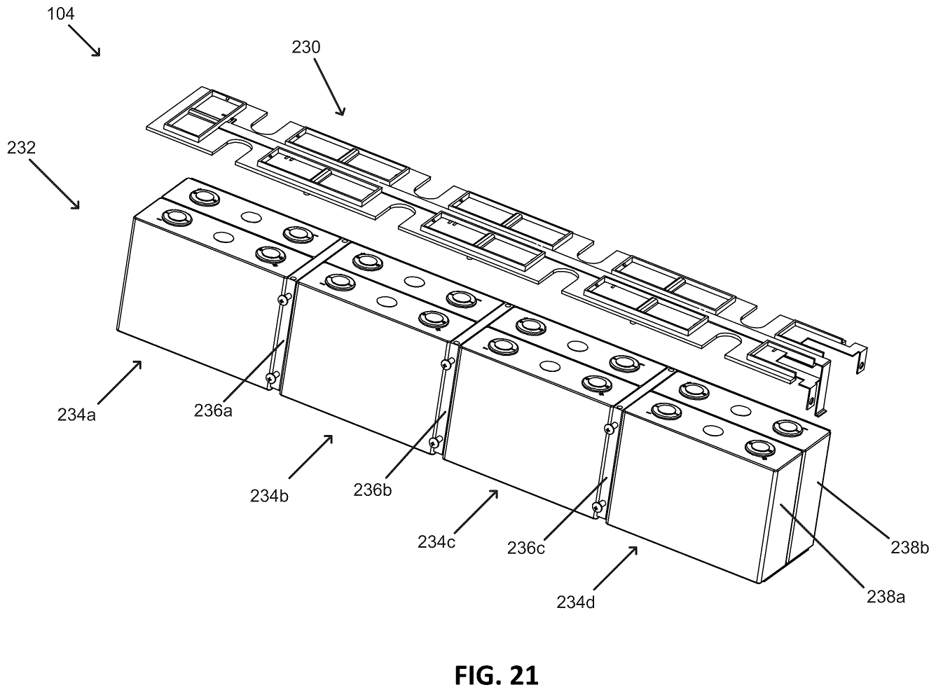

FIG. 21 is an exploded perspective view of the battery portion 104. In some examples, the battery portion 104 includes a bus assembly 230 and a battery pack 232. In some examples, the battery pack 232 includes one or more battery stacks 234a, 234b, 234c, 234d and one or more barriers 236a, 236b, 236c. In some examples, each battery stack 234 includes one or more battery cells 238a, 238b.

In some examples, the bus assembly 230 is arranged on top of the battery pack 232. In some examples, the bus assembly 230 is electrically connected to the battery pack 232. In some examples, the bus assembly 230 is further electrically connected to the control portion 106.

In some examples, while not illustrated in FIG. 21, the battery portion 104 further includes a top barrier. In some examples, the top barrier is arranged on top of the bus assembly 230 such that the bus assembly 230 is arranged between the battery pack 232 and the top barrier. In some examples the top barrier comprises a dielectric barrier. In some examples, the top barrier provides a dielectric barrier between the bus assembly 230 and the top panel 108 of the housing 102. In some examples, when the battery module assembly 100 is fully assembled, the top barrier is in contact with the top panel 108, however, does not contact the bus assembly 230 such that there is a gap between the top barrier and the bus assembly 230.

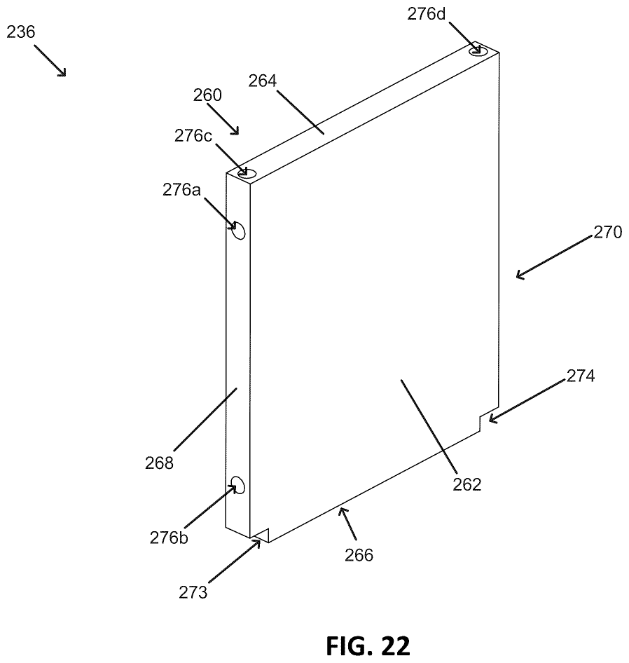

FIG. 22 is a perspective view of an example barrier 236. While the shape of the barrier 236 may vary, the barrier 236 is generally planar in shape and therefore includes a first battery contacting surface 260 and a second battery contacting surface 262. In some examples, such as the example of FIG. 21, the barrier is generally rectangular in shape. In this example, the barrier 236 includes a first battery contacting surface 260, a second battery contacting surface 262, a top surface 264, a bottom surface 266, a front surface 268, a rear surface 270, a front notch 273, a rear notch 274, and one or more through holes 276.

In some examples, the barrier includes a first through hole 276a, a second through hole 276b, a third through hole 276c, and a fourth through hole 276d. In other examples, the barrier includes additional through holes 276. In some examples, the first through hole 276a and the second through hole 276b extend from the front surface 268 through the barrier 236 and out of the rear surface 270. In some examples, the third through hole 276c and the fourth through hole 276d extend through the top surface 264 through the barrier 236 and out of the bottom surface 266. In some examples, the barrier 236 includes additional though holes 276 extending though the body of the barrier 236. In some examples, the through holes 276 may comprise openings of various shapes and sizes. In some examples, the through holes 276 extend from the first battery contacting surface 260 through the barrier 236 and out of the second battery contacting surface 262.

In some examples, when arranged within the battery module assembly 100, the fasteners 122 extend through the first through holes 276a and the second through holes 276b of the barriers 236. In some examples, the through holes 276a, 276b, 276c, 276d are tapered such that the largest point of the through holes 276 is at the opening of the through holes 276. In these examples, the tapered design of the through holes 276 may be beneficial as to align the fasteners 122 when the fasteners 122 are inserted into the through holes 276.

In some examples, the barrier 236 is formed as a mesh material in which the barrier 236 includes many through holes 276 that extend between the first battery contacting surface 260 and the second battery contacting surface 262.

In some examples, the front notch 273 extends from the first battery contacting surface 260 through the second battery contacting surface 262. In some examples, the front notch 273 further extends through the front surface 268 and the bottom surface 266. In some examples, the rear notch 274 extends from the first battery contacting surface 260 through the second battery contacting surface 262. In some examples, the rear notch 274 further extends through the rear surface 270 and the bottom surface 266.

In some examples, the barriers 236 are thermal insulating barriers. In some examples, the barriers 236 are made from ceramic, plastic, adhesive, and/or foam materials. In some examples, the barriers 236 have approximately 1.73-watt thermal resistivity and are capable of withstanding temperatures of approximately 250C. In some examples, the barriers 236 are configured and/or constructed to reduce the possibility of thermal runaway operation in the battery module assembly 100. In some examples, the barriers comprise an electrically insulating material. In some examples, when arranged in the battery module assembly 100, the barriers 236 are not compressed.

In some examples, each of the barriers 236 are formed from multiple pieces, rather than as a single piece. In such examples, the multiple pieces of each of the barriers 236 are capable of mating together to form the barrier 236.

In some examples, each of the barriers 236 include pockets formed on the first battery contacting surface 260 and/or the second battery contacting surface 262. In such examples, the pockets do extend all the way through the barrier 236.

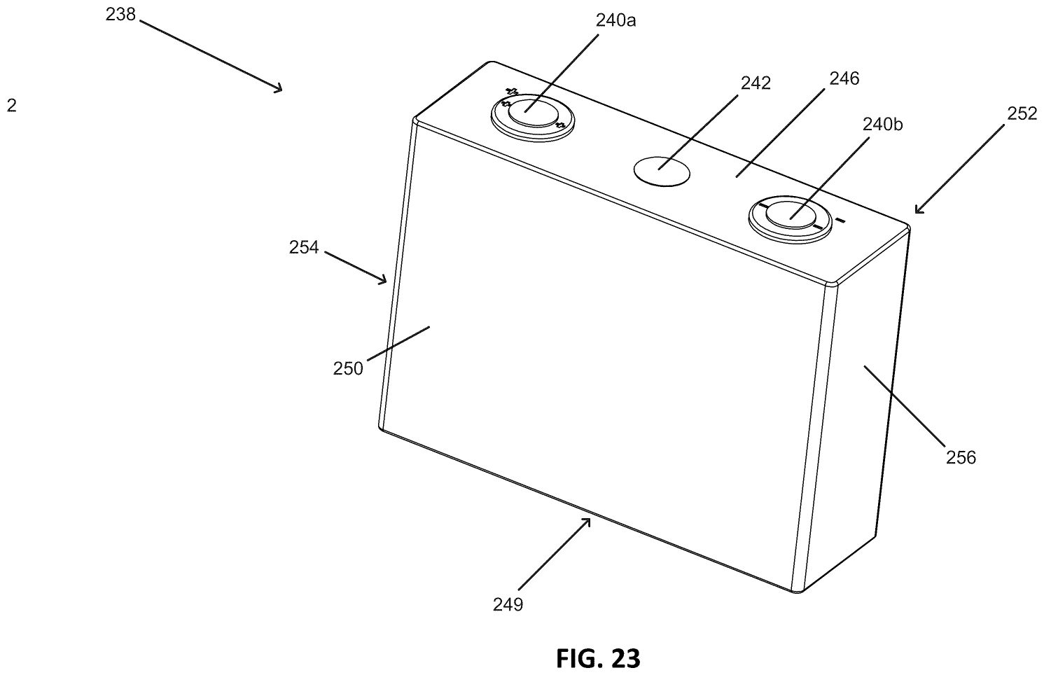

FIG. 23 is a perspective view of an example battery cell 238 of the example battery pack 232. In some examples, the battery cell 238 is a prismatic battery cell. In the example of FIG. 23, the battery cell 238 includes a top surface 246, a bottom surface 249, a front surface 250, a rear surface 252, a right surface 254, a left surface 256, one or more terminals 240, and one or more vents 242. In some examples, the one or more terminals 240 include a first terminal 240a and a second terminal 240b.

In some examples, the top surface 246 is arranged parallel to and opposite the bottom surface 249. In some examples, the front surface 250 is arranged parallel to and opposite the rear surface 252. In some examples, each of the front surface 250 and the rear surface 252 are arranged perpendicularly to each of the top surface 246 and the bottom surface 249. In some examples, the right surface 254 is arranged parallel to and opposite the left surface 256. In some examples each of the right surface 254 and the left surface 256 are arranged perpendicularly to the front surface 250, the rear surface 252.

In some examples, the surface area of the front surface 250 is equal to the surface area of the rear surface 252. In some examples, the surface area of the left surface 256 is equal to the surface area of the right surface 254. In some examples, the surface area of the top surface 246 is equal to the surface area of the bottom surface 249.

In some examples, the surface area of the front surface 250 is larger than the surface area of the top surface 246 and/or the surface area of the right surface 254.

In some examples, the above-described surfaces of the battery cell 238 are not exactly parallel, perpendicular, or equal in surface area due to imperfections in the manufacturing processes, tolerancing defects, surface imperfections, or wear during post-manufacturing processing, shipment, or use.

In some examples, the vent 242 and the terminals 240 are both arranged on the top surface of the battery cell 238. In some examples, arrangement of the vent 242 on the top surface of the battery cell 238 is beneficial, as it facilitates the venting of gases produced by the battery cell 238 from the battery cell 238.

In some examples, the battery cell 238 may have any type of chemistry, such as, for example, lithium-ion, lithium iron phosphate, lithium cobalt magnesium, nickel-metal hydride, nickel-cadmium, sodium nickel chloride, solid state lithium.

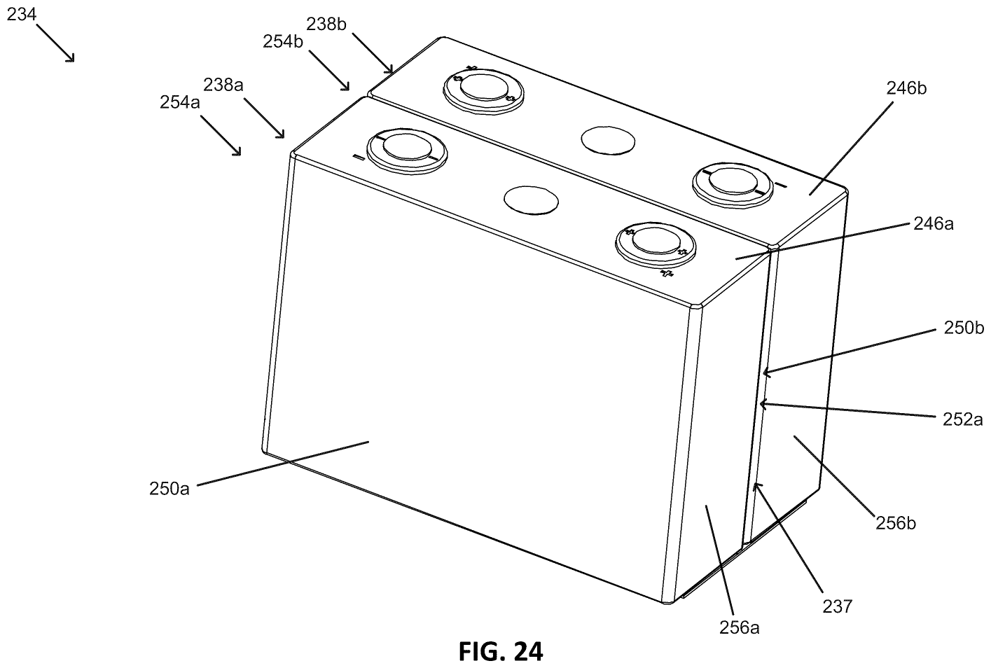

FIG. 24 is a perspective view of an example battery stack 234 of the example battery pack 232. In some examples, each battery stack 234 includes one or more battery cells 238. In some examples, such as the example of FIG. 24, each battery stack 234 includes two battery cells 238a, 238b. In other examples, different numbers of battery cells 238 may be used, such as, for example, three, four, five, or six battery cells 238. In some examples, each battery stack 234 includes only two battery cells 238.

In some examples, when arranged in the battery stack 234, a first battery cell 238a and a second battery cell 238b are arranged such that the front surface 250b of the second battery cell 238b abuts the rear surface 252a of the first battery cell 238a. In some examples, in this arrangement, the front surface 250b of the second battery cell 238b contacts the rear surface 252a of the first battery cell 238a. In some examples, when placed into this arrangement, the front surface 250a of the first battery cell 238a is parallel to the front face of the second battery cell 238b. In some examples, as shown in FIG. 24, the first battery cell 238a and the second battery cell 238b are arranged such that the left surface 256a of the first battery cell 238a and the right surface 256b of the second battery cell 238b are coplanar to one another. Likewise, in some examples, the top surface 246a and top surface 246b are coplanar, the side surface 254a and side surface 254b are coplanar, and the bottom surface 249a and bottom surface 249b are coplanar.

In some examples, as noted above, the above-described surfaces of the battery cell 238 are not exactly parallel or coplanar due to imperfections in the manufacturing processes, tolerancing defects, surface imperfections, or wear during post-manufacturing processing, shipment, or use.

In some examples, the arrangement of the battery stack 234 creates a seam 237 between the battery cells 238 of the battery stack 234. In some examples, the seam 237 is the plane along which the first battery cell 238a contacts the second battery cell 238b, either directly or indirectly. In some examples, such as when the battery stack 234 includes only two battery cells 238, each battery stack 234 includes a single seam 237. However, in other examples, such as when the battery stack 234 includes more than two battery cells 238, each battery stack 234 includes multiple seams 237. In some examples, the number of seams in each battery stack 234 is equal to y−1, wherein y is equal to the number of battery cells 238 in the battery stack 234.

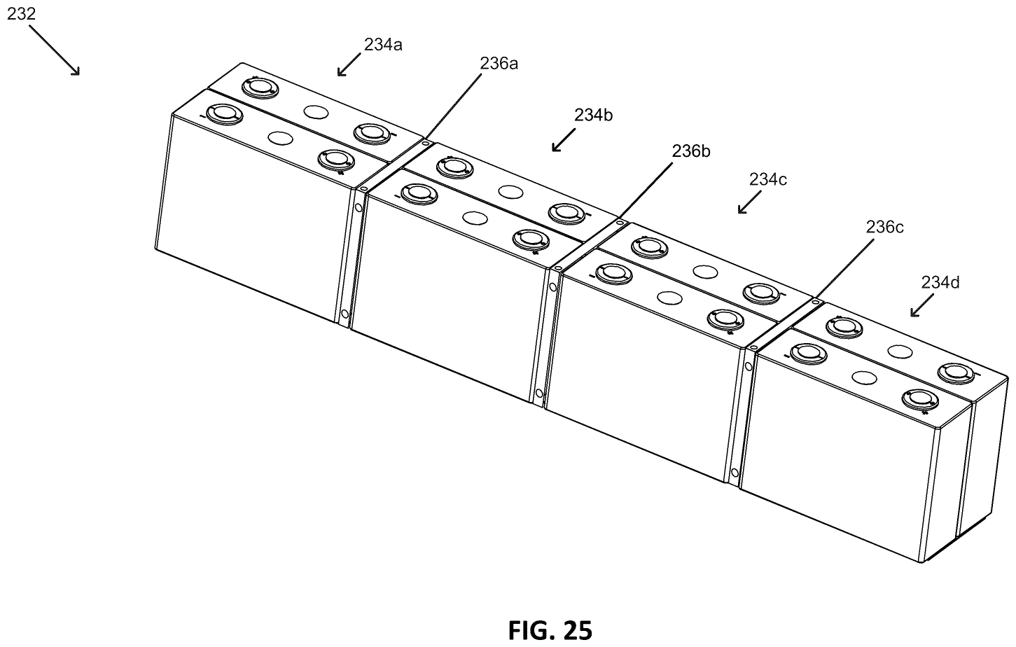

FIG. 25 is a perspective view of the battery pack 232. The battery pack includes one or more battery stacks 234 and one or more barriers 236. In some examples, as shown in FIG. 25, the battery pack 232 includes four battery stacks 234a, 234b, 234c, 234d. In other examples, the battery pack 232 includes other numbers of battery stacks 234, such as, for example, two, three, five, six, seven, eight, nine, or ten battery stacks 234. In some examples, each of the battery stacks 234 are arranged adjacent to one another. In some examples, each of the adjacent battery stacks 234 are separated from each other by a barrier 236a, 236b, 236c. Thus, in some examples, the battery pack 232 includes n−1 barriers 236, wherein n is the number of battery stacks 234 contained within the battery pack 232.

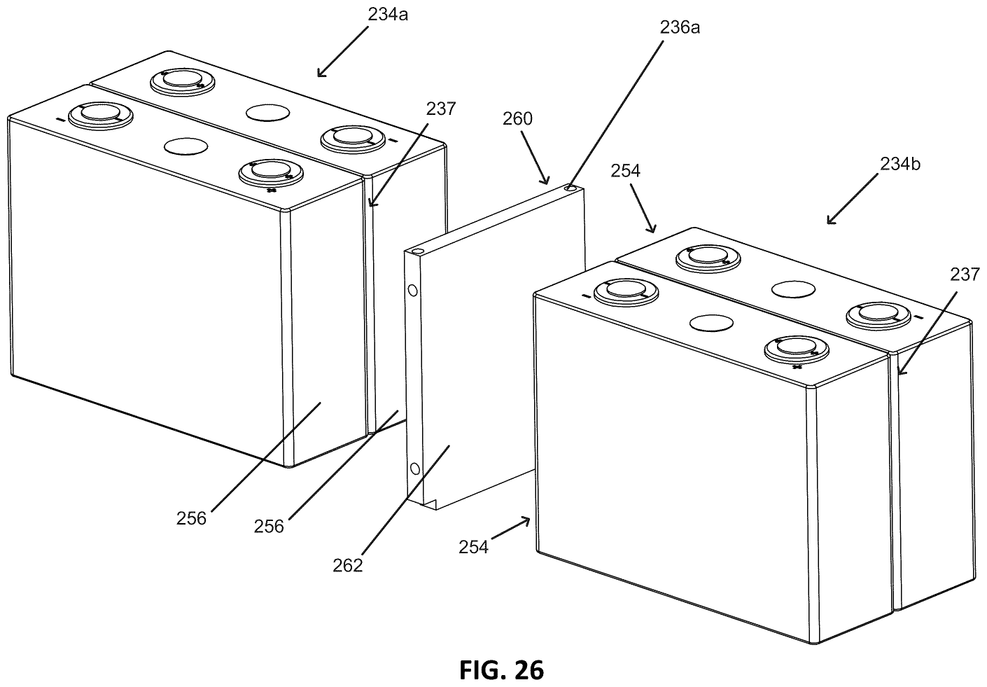

FIG. 26 is an exploded perspective view of a portion of the battery pack 232 including a first battery stack 234a, a second battery stack 234b, and a first barrier 236a. In some examples, the first barrier 236a is arranged between the first battery stack 234a and the second battery stack 234b such that the first battery contacting surface 260 of the first barrier 236a contacts the first battery stack 234a and the second battery contacting surface 262 of the first barrier 236a contacts the second battery stack 234b. In some examples, the first battery contacting surface of the first barrier 236a is parallel to and contacts the left surfaces 256 of the battery cells 238 of the first battery stack 234a and the second battery contacting surface 262 of the barrier 236a is parallel to and contacts the right surfaces 254 of the battery cells 238 of the second battery stack 234b. In some examples, the first battery contacting surface 260 and the second battery contacting surface 262 of the first barrier 236a are arranged perpendicularly with respect to the front surface 250 and the rear surface 252 of the battery cells 238 in the first battery stack 234a and the second battery stack 234b. In some examples, the first battery contacting surface 260 and the second battery contacting surface 262 of the first barrier 236a are arranged perpendicularly with respect to the seams 237 of the first battery stack 234a and the second battery stack 234b.

In some examples, despite being separated by the first barrier 236a, the first battery stack 234a and the second battery stack 234b are arranged such that the seam 237 of the first battery stack 234a and the seam 237 of the second battery stack 234b are coplanar with each other.

In some examples, such as in the example of in FIG. 25, the second barrier 236b is arranged similarly with respect to the second battery stack 234b and the third battery stack 234c, and the third barrier 236c is arranged similarly with respect to the third battery stack 234c and the fourth battery stack 234d as the first barrier 236a is arranged with respect to the first battery stack 234a and the second battery stack 234a, as described above.

In some examples, a thermal sheet may be arranged within the seam 237 of the battery stacks 234. In some examples, the thermal sheet is a heating element, such as for example, a film heater. In other examples, the thermal sheet is the thermal sheet 128 described with respect to FIG. 8. In some examples, the thermal sheet extends along the length of the battery pack 232 within the seam 237 in each of the battery stacks 234 of the battery pack 232. In some examples, the barriers 236 include openings for the thermal sheet to pass as the thermal sheet extends between the battery stacks 234 within the seams 237. In some example, arrangement of the thermal sheet within the seam 237 allows for a greater surface area of the battery cells 238 to be contacted by the thermal sheet, as the thermal sheet is able to contact the front surface 250 and the rear surfaces 252 (which are the surfaces with the largest surface area) of the battery cells 238.

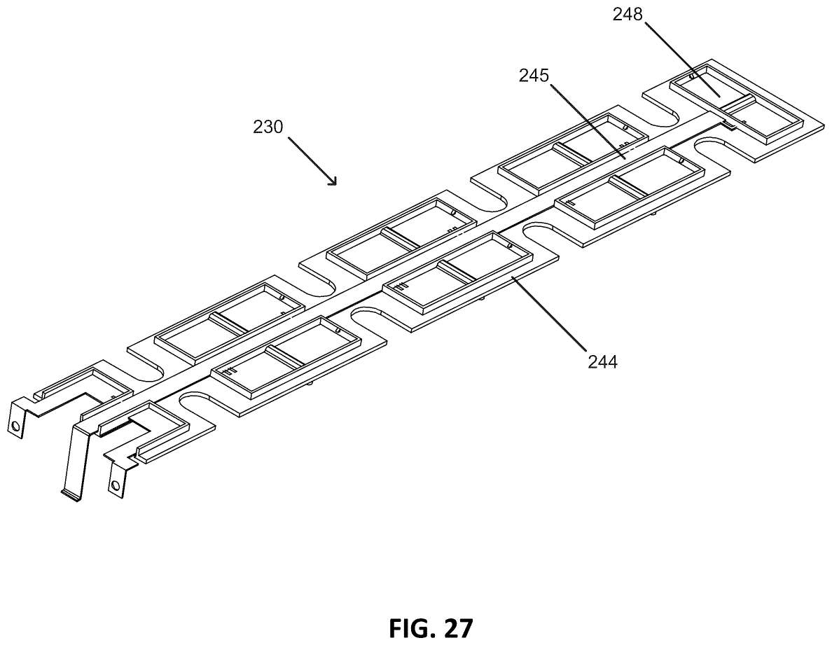

FIG. 27 is a perspective view of the bus assembly 230. The bus assembly 230 includes a frame 244, a board 245, and a plurality of bus contacts 248. In some examples, the board 245 and the bus contacts 248 are arranged on the frame when the bus assembly 230 is mounted upon the battery pack 232.

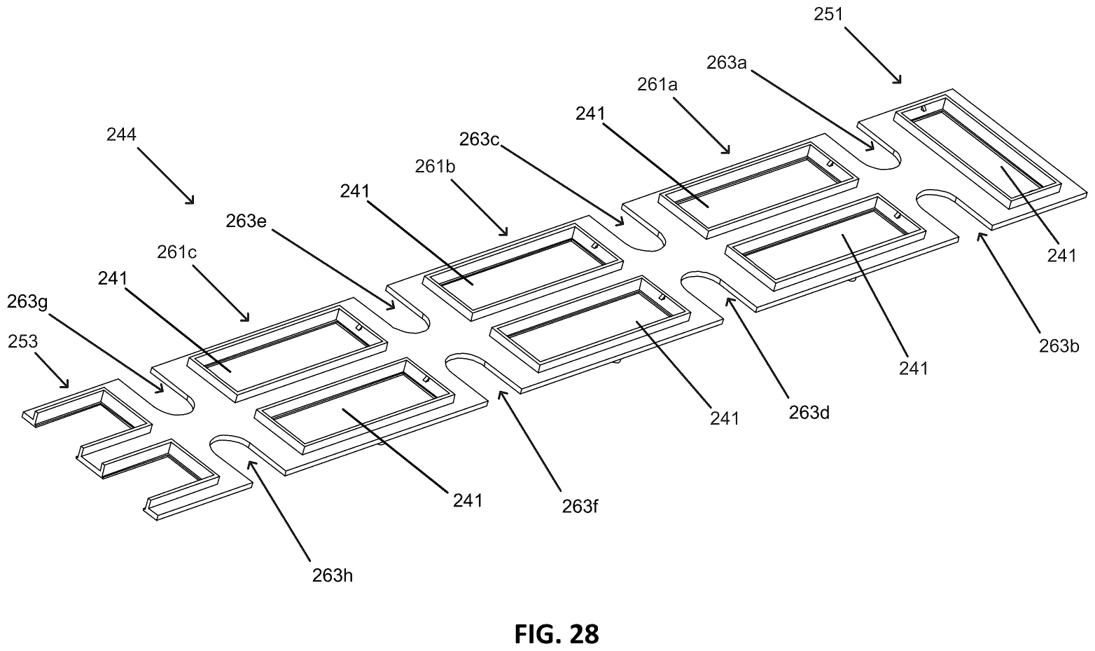

FIG. 28 is a perspective view of the frame 244. In some examples, the frame 244 includes a plurality of bus contact holders 241 and a plurality of vent cutouts 263. In some examples, the bus contact holders 241 are arranged in bus contact holder pairs 261 along the length of the frame 244. In other examples, the bus contact holders 241 are arranged as singular bus contact holders along the frame 244. In some examples, such as the example of FIG. 28, one bus contact holder 241 is arranged singularly as a singular bus contact holder 251 at one end of the frame 244 while a plurality of bus contact holder pairs 261a, 261b, 261c are arranged along the length of the frame 244. In this example, the singular bus contact holder 251 is arranged transversely across the frame 244 while each bus contact holder 241 of the bus contact holder pairs 261a, 261b, 261c are arranged longitudinally along the frame 244. In some examples, the arrangement of the singular bus contact holder 251 and the bus contact holder pairs 261 along the frame 244 mirrors the arrangement of the first rectangular pair 184, second rectangular pair 186, third rectangular pair 188 and transverse rectangle 190 of the top panel 108 of the housing 102. In some examples, the bus contact holders 241 are each formed as openings in the frame 244 with an upwardly extending flange arranged about the opening.

In some examples, the frame 244 further includes a partial bus contact holder pair 253 arranged at an end of the frame 244 opposite the singular bus contact holder 251. In some example, the partial bus contact holder pair 253 is formed substantially similar to a bus contact holder pair 261 but is cut in half transversely across the frame 244.

In some examples, the vent cutouts 263a, 263b, 263c, 263d, 263e, 263f, 263g, 263h are arranged in pairs along the length the frame 244. In some examples, a pair of vent cutouts 263 is arranged between each of the bus contact holder pairs 261a, 261b, 261c, the singular bus contact holder 251, and the partial bus contact holder pair 253.

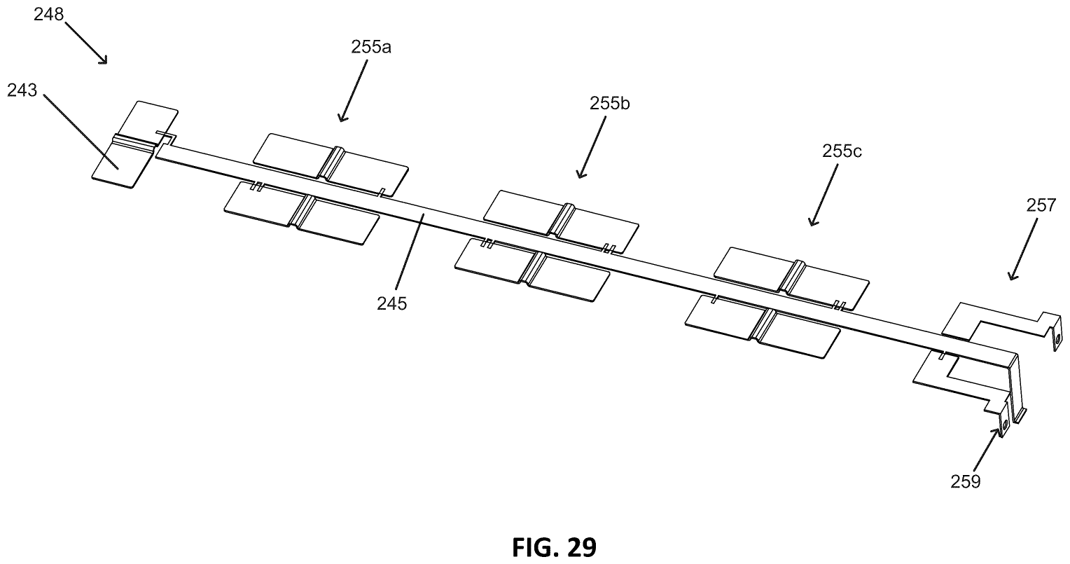

FIG. 29 is a perspective view of the bus contacts 248 connected to the board 245. In some examples, the bus contacts 248 are arranged along the length of the board 245 singularly, in pairs, or in a half pair in a similar arrangement to the arrangement of the bus contact holders 241 on the frame 244. Thus, in some examples, the bus contacts 248 include a singular bus contact 243, bus contact pairs 255a, 255b, 255c, and a half bus contact pair 257. In some examples, the bus contacts 248 are each electrically connected to the board 245. In some examples, the bus contacts 248 are connected to the board 245 by welding.

In some examples, the bus contacts 248 include conductive pads for contacting the terminals 240 of the battery cells 238. In some examples, the bus contacts 248 assist in transmitting signals from the terminals 240 of the battery cells 238.

In some examples, the half bus contact pair 257 further includes a pair of tabs 259. In some examples, the pair of tabs 259 interfaces with the control portion 106 of the battery module assembly 100.

In some examples, the board 245 is a flexible printed circuit board that includes one or more conductors. In some examples, the board 245 includes multiple conductors extending along its length. In some examples, the conductors are configured to transmit electrical signals from the bus contacts 248.

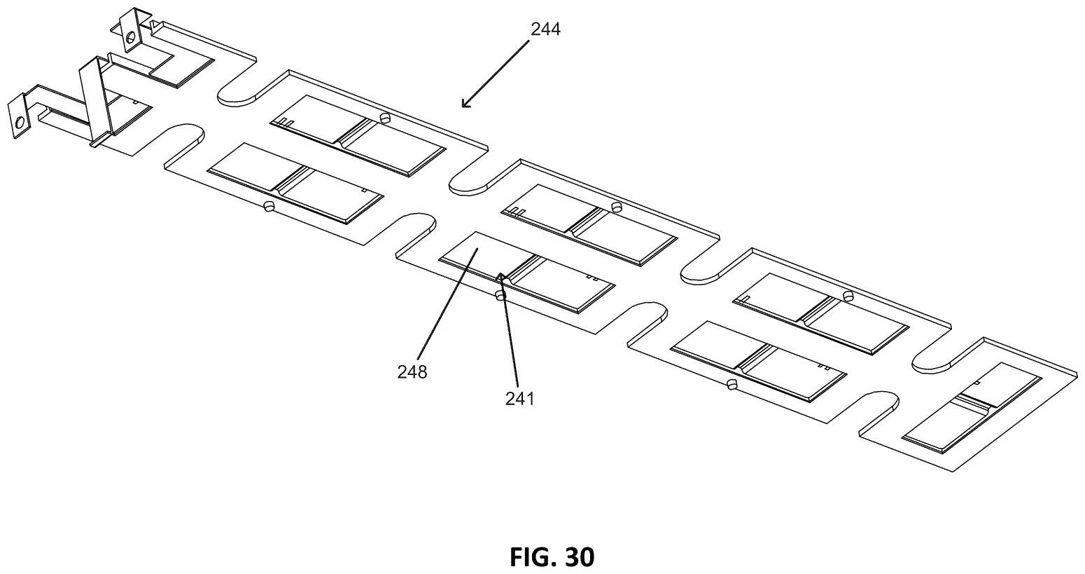

FIG. 30 is a bottom view of the example bus assembly 230. In some examples, as shown in FIG. 30, when arranged on the frame 244, the bus contacts 248 are unsupported in the area underneath the bus contacts 248 by the frame 244 due to the lack of material within the bus contact holders 241. Thus, the bus contacts 248 are able to contact the terminals 240 on the battery cells 238 when arranged over the battery pack 232.

In some examples, the example bus assembly 230 further includes voltage measurement and temperature measurement devices. In these examples, the bus assembly 230 is able to measure voltage and temperature data about the battery cells 238 and communicate that data to the control portion 106 of the battery module assembly 100.

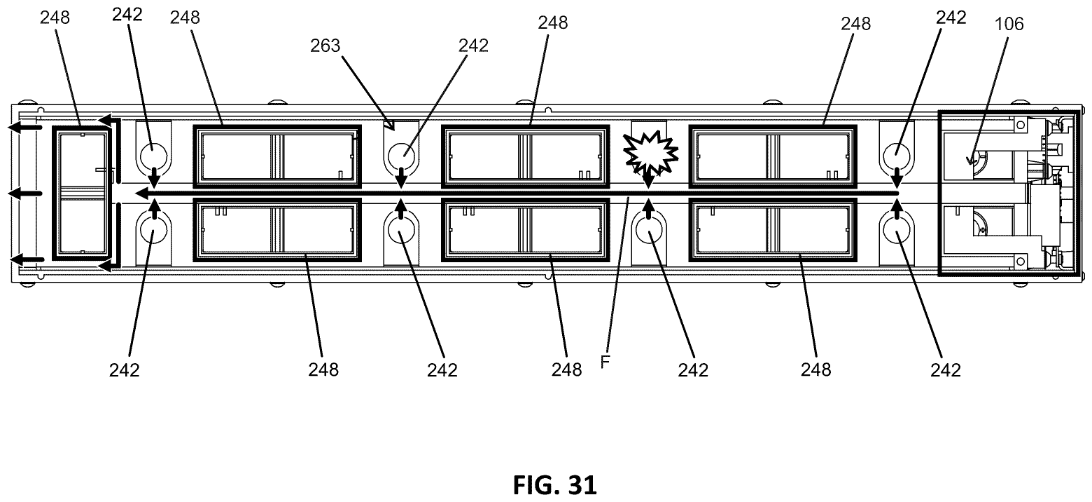

FIG. 31 is a top perspective view of the battery module assembly 100 with a top panel 108 shown as being transparent. In some examples, over the life of the battery cells 238, the battery cells may emit gasses when exposed to certain physical conditions. These gasses may include oxygen, carbon dioxide, carbon monoxide, or hydrogen. In some examples, the gasses are emitted from the battery cells 238 vie the vents 242 on the top surface 246 of the battery cells 238. In some examples, when the battery cells 238 and the bus assembly 230 are arranged together in the battery module assembly 100, the gasses are emitted from the battery cells 238 through the vents 242 and through the vent cutouts 263 of the bus assembly 230. In some examples, it may be beneficial to keep the gasses emitted from the battery cells 238 isolated from other exposed electrical components of the battery module assembly 100, such as, for example, the bus contacts 248 or the control portion 106 of the battery module assembly 100. In some examples, the geometry of the top panel 108 and the frame 244 of the bus assembly 230 aid in performing this function. As previously described with respect to FIGS. 14 and 28, the top panel 108 includes a series of downwardly extending flanges including a transverse rectangle 190, a first rectangular pair 184, a second rectangular pair 186, a third rectangular pair 188 and a transverse flange 192, while the frame 244 of the bus assembly 230 includes bus contact holders 241 with upwardly extending flanges arranged in a similar and corresponding manner. In some examples, the upwardly extending flanges of the bus contact holders 241 mate with the downwardly extending flanges of the transverse rectangle 190, a first rectangular pair 184, a second rectangular pair 186, a third rectangular pair 188 and transverse flange 192 to isolate the control portion 106 and the bus contacts 248 held within the bus contact holders 241 from the gasses produced by the battery cells 238. In some examples, this arrangement causes the gasses emitted by the battery cells 238 to follow the flow path F illustrated by the arrows in FIG. 31.

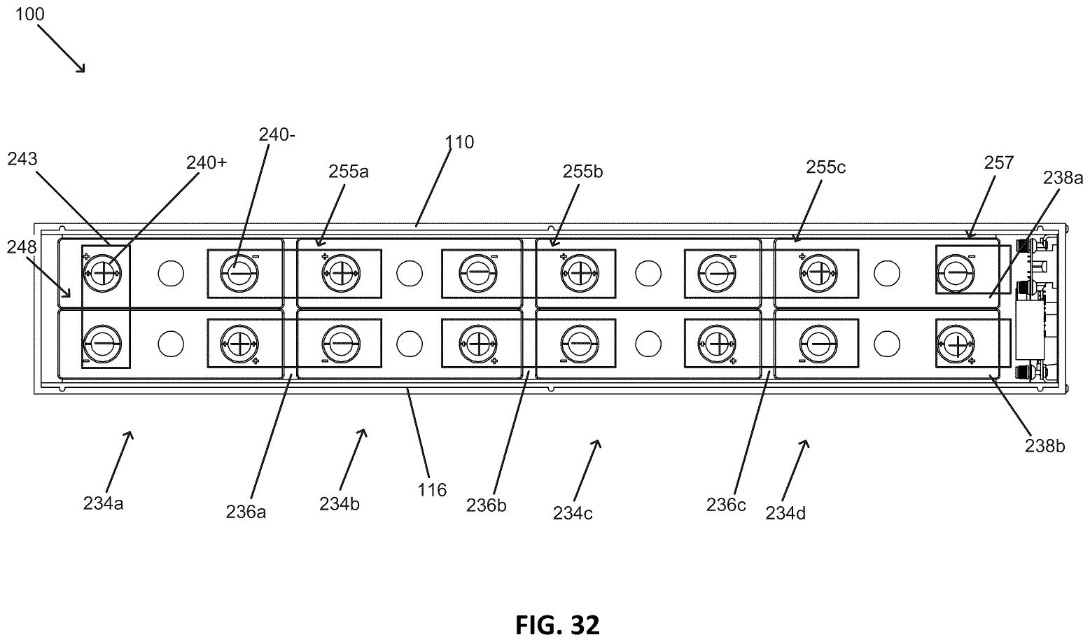

FIG. 32 is a top view of the battery module assembly 100 detailing the polarity of the battery cells 238 and bus contacts 248 with the top panel 108 and the bus assembly 230 removed.

As illustrated by FIG. 32, each of the battery stacks 234 includes a first battery cell 238a arranged adjacent to the front panel 110 of the battery module assembly 100 and a second battery cell 238b arranged adjacent to the rear panel 116 of the battery module assembly 100. The battery cells 238 are arranged in the battery module assembly 100 with alternating polarity. As illustrated by FIG. 32, each of the battery cells 238 includes a positive terminal 240+ and a negative terminal 240−. In the example of FIG. 32, the positive terminal 240+ of the first battery cell 238a of the first battery stack 234a is arranged to the left of the negative terminal 240−. The positive terminal 240+ of the second battery cell 238b of the first battery stack 234a is arranged to the right of the negative terminal 240−. Similarly, the positive terminal 240+ of the first battery cell 238a of the second battery stack 234a is arranged to the left of the negative terminal 240−. The positive terminal 240+ of the second battery cell 238b of the second battery stack 234a is arranged to the right of the negative terminal 240−. The battery cells 238 of the second battery stack 234b and the third battery stack 234c are similarly arranged.

In some examples, as illustrated in FIG. 32, each of the bus contacts 248 contacts a positive terminal 240+ of one battery cell 238 and a negative terminal of another battery cell 238. For example, the singular bus contact 243 contacts the positive terminal 240+ of the first battery cell 238a of the first battery stack 234a and the negative terminal 240− of the second battery cell 238b of the first battery stack 234a.

As another example, one of the bus contacts 248 of the first bus contact pair 255a contacts the negative terminal 240− of the first battery cell 238a of the first battery stack 234a and the positive terminal 240+ of the first battery cell 238a of the second battery stack 234b. the other bus contact 248 of the first bus contact pair 255a contacts the positive terminal 240+ of the second battery cell 238b of the first battery stack 234a and the negative terminal 240− of the second battery cell 238b of the second battery stack 234b. In this example, each of the bus contacts 248 of the first bus contact pair 255a cross the first barrier 236a between the points of contact of the positive terminals 240+ and the negative terminal 240−.

In some examples, the second bus contact pair 255b is arranged similarly with respect to the second battery stack 234b and the third battery stack 234c, and the third bus contact pair 255c is arranged similarly with respect to the third battery stack 234c and the fourth battery stack 234d.

In some examples the half bus contact pair 257 is arranged to contact the negative terminal 240− of the first battery cell 238a of the fourth battery stack 234d and the positive terminal 240+ of the second battery cell 238b of the fourth battery stack 234d.

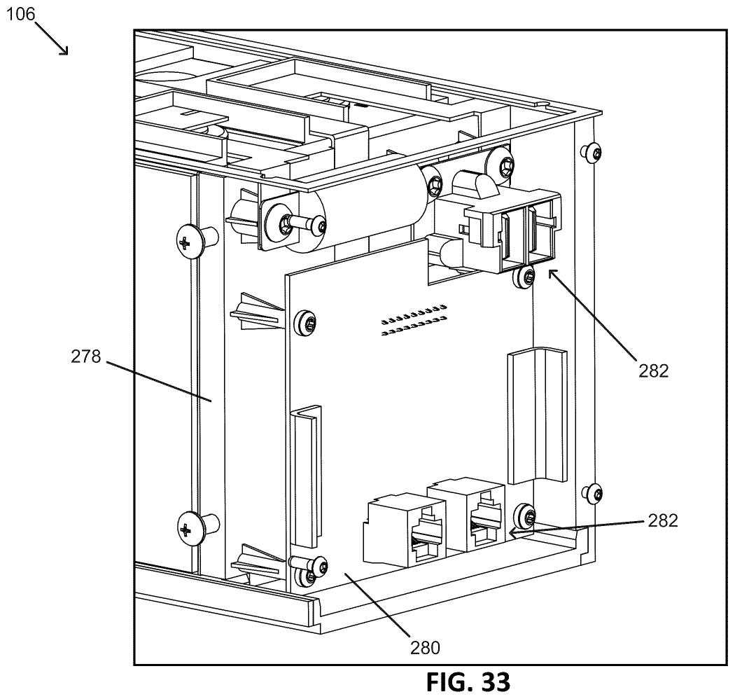

FIG. 33 is a perspective view of the example control portion 106. In some examples the control portion 106 includes a rear plate 278, a control board 280, one or more connectors 282, one or more resistors, and one or more fuses. In some examples, the control portion 106 monitors signals transmitted from the bus assembly 230 indicative of the temperature of the state of the battery pack 232. In some examples, the transmitted signals are indicative of the temperature and/or voltage of the battery cells 238. In some examples, the control portion 106 is connected to the bus assembly 230 by the board 245 and the tabs 259 of the half bus contact pair 257, through which the signals are transmitted.

In some examples, the connectors 282 allow for the transmission of the voltage and temperature signals outside of the battery module assembly 100. In some examples, the connectors 282 allow for the transmission of power produced by the battery cells 238 out of the battery module assembly 100 for powering external devices. In some examples, the connectors 282 allow for the transmission of power to the battery cells 238 for charging the battery cells 238.

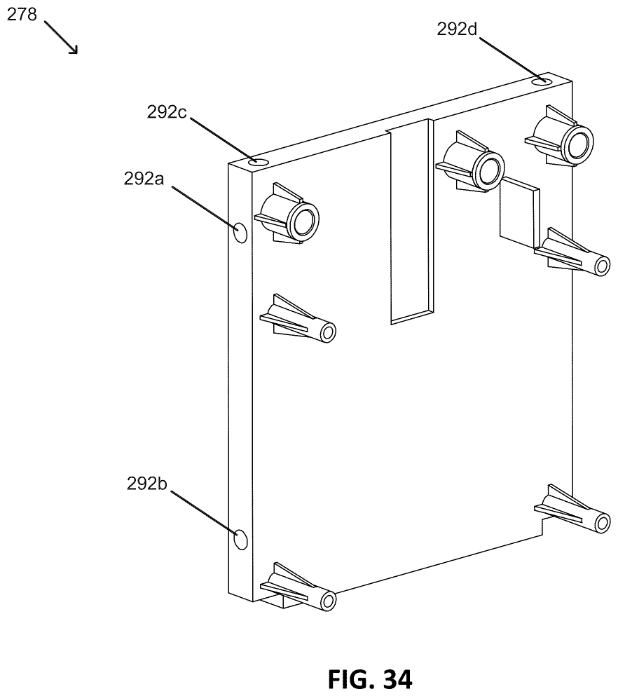

FIG. 34 is a perspective view of the example rear plate 278. In some examples, the rear plate 278 is configured to support the control board 280. In some examples, the rear plate 278 is further configured to support the one or more resistors, the one or more fuses, and/or the one or more connectors. In some examples, the rear plate 278 includes a plurality of through holes, such as, for example, a first through hole 292a, a second through hole 292b, a third through hole 292c, and a fourth through hole 292d. In some examples, the through holes 292a, 292b receive fasteners 122 therethrough. In some examples, when arranged in the battery module assembly 100, the rear plate 278 is arranged between the fourth battery stack 234d and the right panel 112.

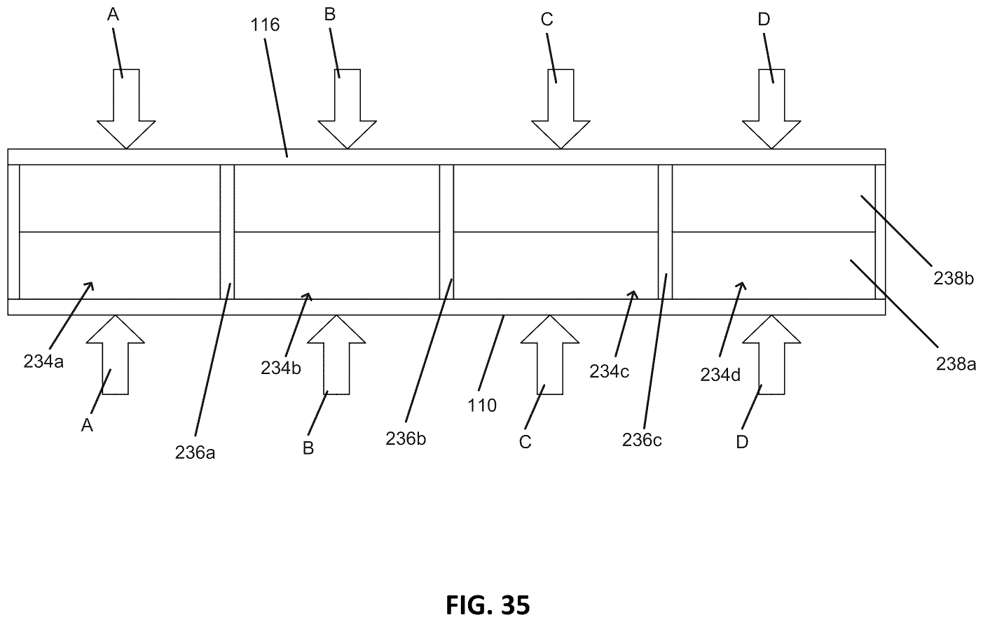

FIG. 35 is a top schematic view of the example battery module assembly illustrating the compression profile of the battery portion 104 by the housing 102.

In some applications, it is useful to compress the battery cells 238 within the battery pack 232. In some applications compression of the battery cells 238 helps to ensure good thermal contact between the battery cells and any cooling or heat dissipation elements within the battery pack. In other applications, compressing the battery cells 238 provides mechanical stability to the battery pack 232. This helps prevent the battery cells 238 from shifting or moving within the battery pack 232. In some applications, during charge and discharge cycles, battery cells 238 may undergo a slight expansion and contraction. Compression can help mitigate this expansion, reducing the risk of damage to the battery cells 238 or the battery pack 232. It also helps maintain consistent electrical and mechanical contact between battery cells 238.

As shown in FIG. 35, the battery cells 238 are arranged in the layout previously described with respect to FIGS. 24-26. When arranged in this configuration, the front panel 110 of the housing 102 contacts the front surface 250 of the first battery cell 238a of each of the battery stacks 234 and the rear panel 116 contacts the rear surface 252 of the second battery cell 238b of each of the battery stacks 234. In some examples, the housing 102 is configured such that the front panel 110 and the rear panel 116 are drawn together by tightening the fasteners 122 that extend through each of the front panel 110 and the rear panel 116. As the fasteners are tightened and the front panel 110 and rear panel 116 are drawn together, the front panel 110 and the rear panel 116 exert a compressive force on each of the battery stacks 234, as illustrated by arrows A, B, C, and D. In this example, the compressive force exerted by the front panel 110 and the rear panel 116 is oriented perpendicularly to the planar arrangement of the barriers 236a, 236b, and 236c separating the first battery stack 234a, second battery stack 234b, and third battery stack 234c.

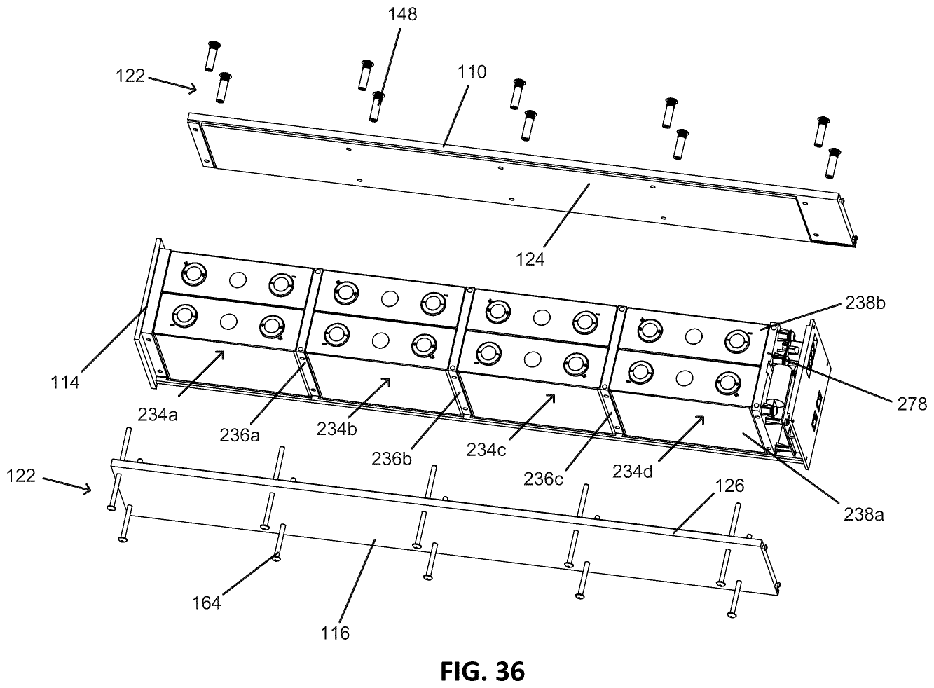

FIG. 36 is an exploded top perspective view of portions of the battery module assembly 100. As shown in FIG. 36, the compressive forces of FIG. 35 are exerted by the front panel 110 and the rear panel 116 as the front panel 110 and rear panel 116 are drawn together against the battery stacks 234a, 234b, 234c, 234d. In some examples, the front panel 110 and the rear panel 116 are drawn together as the male portions 164 of the fasteners 122 are threaded into the female portions 148 of the fasteners 122. In some examples, the fasteners 122 extend through the holes 226 of the left panel 114 (labeled in FIG. 16), the through holes 276a, 276b of the barriers 236 (labeled in FIG. 21) and the through holes 292a, 292b of the rear plate 278 (labeled in FIG. 34).

In some examples, the front panel 110 and the rear panel 116 exert a compressive force on the battery stacks 234 through the front lining sheet 124 and the rear lining sheet 126. In some examples, the front lining sheet 124 and the rear lining sheet 126 are sized such that the front lining sheet 124 and rear lining sheet 126 contact the battery stacks 234 when the front panel 110 and rear panel 116 are arranged on the battery module assembly 100 but do not contact the rear plate 278, left panel 114, bottom panel 118 or top panel 108. Thus, in such examples, the front panel 110 and the rear panel 116 are able to exert a compressive force on the battery stacks 234 as the fasteners 122 are tightened while leaving other portions of the battery module assembly, such as the rear plate 278, left panel 114, bottom panel 118 or top panel 108, uncompressed.

In some examples, the compression provided by the front panel 110 and the rear panel 116 in the arrangement described with respect to FIGS. 34 and 35 is beneficial because it generates a relatively uniform compression profile, as front panel 110 and the rear panel 116, which generate the compressive force, have a relatively solid structural integrity.

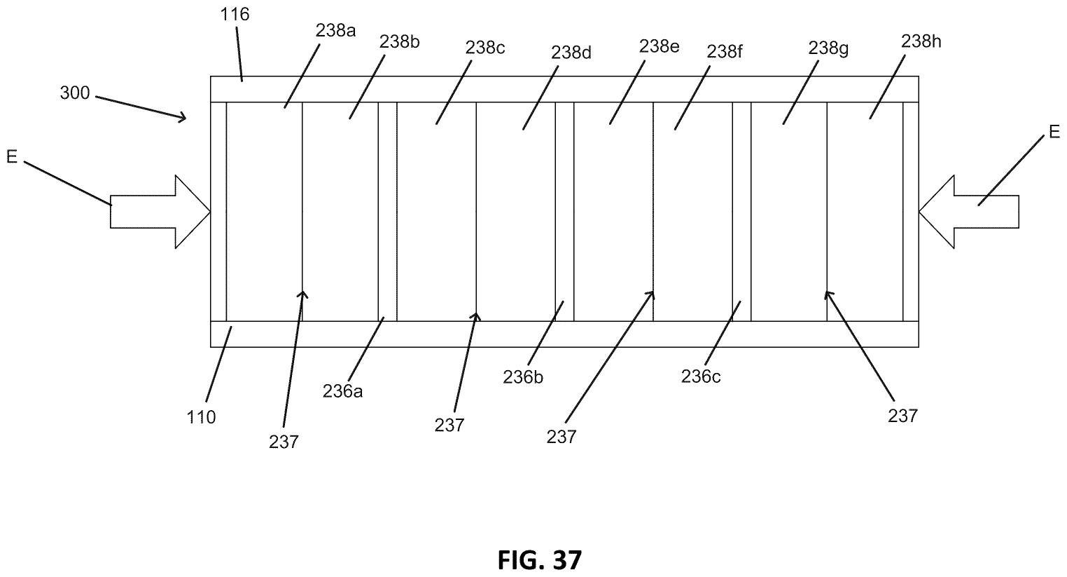

FIG. 37 depicts an alternative arrangement of the battery cells 238a, 238b, 238c, 238c, 238d, 238e, 238f, 238g and the barriers 236a, 236b, 236c, 236d, all of which are arranged in a single battery stack 300. In the example of FIG. 37, the battery cells 238 are arranged in the battery stack 300 such that the seams 237 between the battery cells 238 are arranged parallel to and spaced apart from each other. In this example, the seams 237 are not arranged coplanar. In this example, the rear surface 252 of the first battery cell 238a is contacted by and abuts the front surface 250b of the second battery cell 238b. The rear surface 252b of the second battery cell 238b is contacted by and abuts the first battery contacting surface 260 of the first barrier 236a. The front surface 250c of the third battery cell 238c contacts and abuts the second battery contacting surface 262 of the first barrier 236a. The remaining battery cells 238 and barriers 236 are arranged similarly.

In the example of FIG. 37, compressive force is applied to the battery stack 300, as illustrated by arrows E. In some examples, the compressive force is applied by end plates that contact the front surface 250a of the first battery cell 238a and the rear surface 252h of the eighth battery cell 238h. In other examples, the compressive force is applied to the battery cells by compressive bands. As shown in the example of FIG. 37, while the compressive force is directly applied to the first battery cell 238a and the eighth battery cell 238h by virtue of their placement on the end of the battery stack 300, the compressive force is indirectly applied to battery cells 238b, 238c, 238d, 238e, 238f, 238g by the other battery cells 238.

In some examples, the embodiment depicted in FIG. 37 may suffer from flaws that are remedied by the arrangement disclosed in FIGS. 35 and 36. For example, the indirect compression of the battery cells 238 in the center of the battery stack 300 may result in inconsistent compressive forces being applied, should some of the battery cells 238 exhibit bulging or other distortions. In contrast, using the arrangement of FIGS. 35-36, fewer indirect compressive forces are applied due to fewer numbers of battery cells 238 being compressed in each of the battery stacks 234. Additionally, the use of bands to provide the compressive force may result in lessening of the compressive forces over time if the bands begin to stretch. In contrast, because the front panel 110 and the rear panel 116 of the arrangement of FIGS. 35 and 36 are held in place using fasteners 122, this issue is mitigated using the battery module assembly 100. Furthermore, the assembly of the battery module assembly 100 may be made easier using the arrangement of FIGS. 35 and 36, as the assembly does not require the placement and securement of bands around the battery stacks 234 and instead only involves the routine tightening of fasteners and assembly of the housing 102. Furthermore, in contrast to the battery stack 300 of FIG. 37, in which the barriers 236 are arranged such that the compressive force is applied to the first battery contacting surface 260 and the second battery contacting surface 262 of the barriers 236 to the battery cells 238, in the arrangement of FIGS. 35 and 36, the barriers 236 are not compressed at the first battery contacting surface 260 and second battery contacting surface 262. Rather, in some examples, the barriers 236, when arranged in the battery module assembly 100 remain uncompressed, or at least experience less compressive loading than the barriers 236 arranged in the battery stack 300. Accordingly, the barriers 236 may need not be constructed to withstand large amounts compressive forces. This permits greater flexibility in the material selection and shape of the barriers 236.

Other advantages may be realized by using the previously described arrangement of the battery module assembly 100. One such advantage is the enhanced thermal management capabilities. By arranging the battery cells 238 into the battery stacks 234 such that the front surfaces 250 and the rear surfaces 252 (which are the faces with the largest surface area) of the battery cells 238 contact the front panel 110 and the rear panel 116, more of the surface area of the battery cells 238 is capable of being thermally controlled by a heat sink or a heat source. Thus, the temperature of the battery cells 238 is able to be more directly controlled. In some examples, the battery module assembly 100 is arranged such that the front panel 110 and/or the rear panel 116 permit conductive heat transfer to a cabinet wall or a cover. In some examples, this is accomplished by arranging the fasteners 122 such that the heads of the fasteners 122 do not extend out from the outer surfaces of the front panel 110 and/or or the rear panel 116 which allows the outer surfaces of the front panel 110 and/or or the rear panel 116 to directly contact a cabinet wall or a cover.

In contrast, using the battery stack 300, a greater number of the front surfaces 250 or rear surfaces 252 of the battery cells 238 abut the barriers 236 or another battery cell 238 thereby shielding the front surfaces 250 or rear surfaces 252 and making them more difficult to thermally regulate.

Another advantage of the battery module assembly 100 is the lower profile geometry of the battery pack 232. As shown by a comparison of FIGS. 35 and 37, the battery pack 232 has a smaller thickness (as measured between the front panel 110 and the rear panel 116) than the battery stack 300 of FIG. 37. This may be beneficial in some applications because it results in a more efficient utilization of space when the battery module assembly 100 is arranged in cramped quarters, such as, for example, a residential garage.

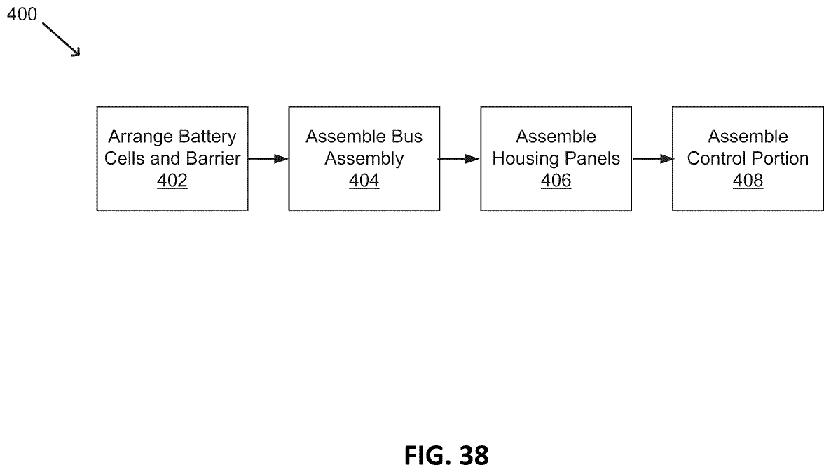

FIG. 38 depicts a method of manufacturing the battery module assembly 100. In some examples, the method 400 includes operations 402, 404, 406, and 408.

Operation 402 includes arranging the battery cells 238 and the barriers 236. In some examples, this includes arranging the battery cells 238 and the barriers 236 onto the bottom panel 118. In some examples, the battery cells 238 are arranged in multiple battery stacks 234 such that each battery stack 234 includes one or more battery cells 238 that are arranged with the longitudinal axis of the battery cells 238 parallel with the longitudinal axis of the bottom panel 118. In some examples, operation 402 includes arrangement of the battery cells 238 into the battery stacks 234 described with reference to FIG. 24. In some examples, operation 402 further includes arrangement of the battery stacks 234 and barriers 236 into the battery pack 232 described with reference to FIG. 25.

Operation 404 includes assembling the bus assembly 230. In some examples, operation 404 includes assembling the board 245 onto the frame 244. In some examples, operation 404 includes assembling the bus contacts 248 onto the frame 244.

In some examples, operation 404 further includes assembling the bus assembly 230 over the battery pack 232 as shown and described with respect to FIGS. 20-21 and 32.

Operation 406 includes assembling the housing 102 panels. In some examples, assembling the housing 102 panels includes assembling the front panel 110, the rear panel 116, the left panel 114, the right panel 112, the top panel 108, and the bottom panel 118. In some examples, operation 406 further includes inserting the fasteners 122 into the respective panels and tightening the fasteners 122 to compress the battery pack 232. In some examples, operation 406 inserting one or more fasteners 122 through one or more barriers 236.

Operation 408 includes assembling the control portion 106. In some examples, assembling the control portion involves arranging the components of the control portion 106 in the arrangement shown and described with respect to FIG. 33.

In some examples, steps of the method 400 need not be performed in any particular order.

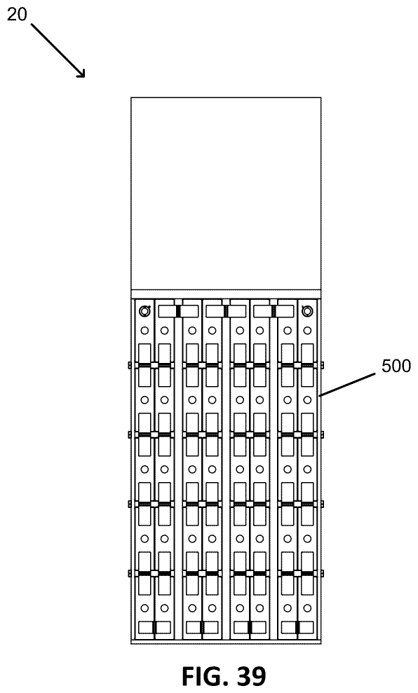

FIG. 39 is a front schematic view of an example energy storage system 20. In some examples, the energy storage system 20 is similar in many aspects to the energy storage system 10 described with reference to FIG. 1.

In some examples, the energy storage system 20 includes a rear surface designed to be mounted to a wall of a building, a front surface opposite the rear surface, and a battery module assembly 500.

In some examples, the battery module assembly 500 is arranged within the energy storage system 20 such that a top surface of a plurality of batteries contained within the energy storage system 20 faces the front surface of the energy storage system 20.

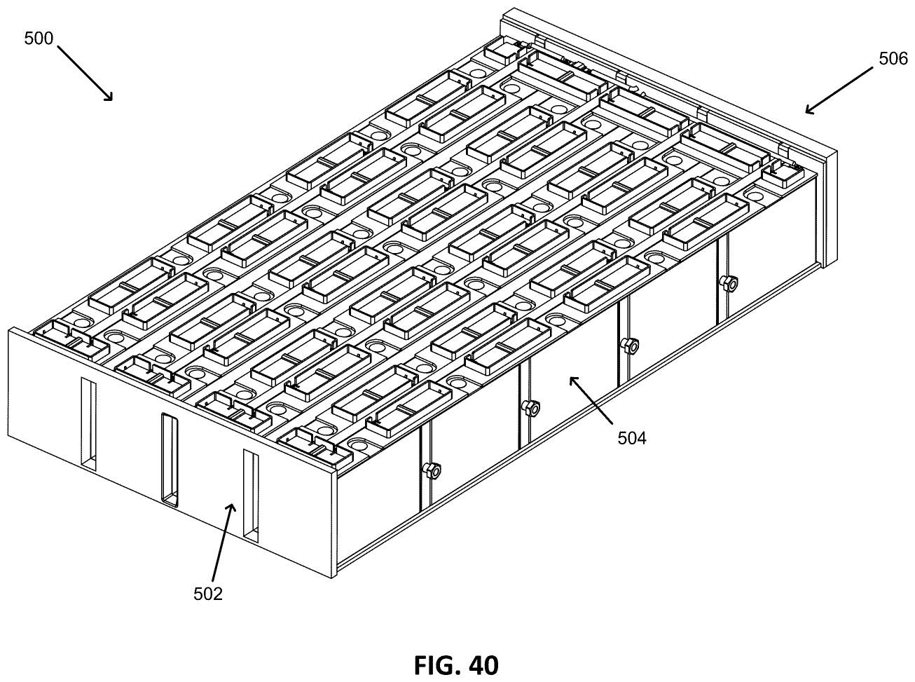

FIG. 40 is a perspective view of the example battery module assembly 500. The battery module assembly 500 is similar in many aspects to the battery module assembly 100. In the example of FIG. 40, the battery module assembly 500 includes a housing 502, a battery portion 504, and a control portion 506.

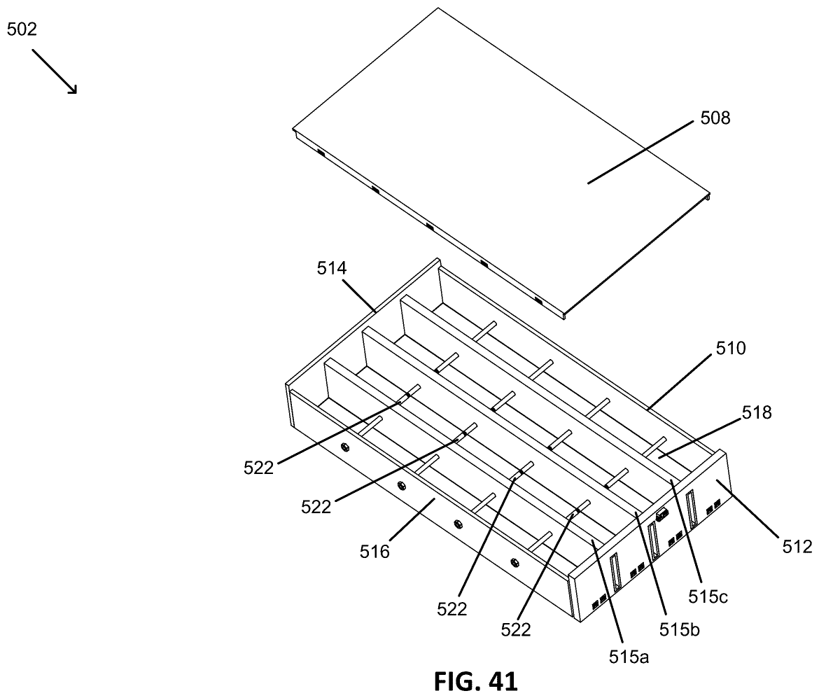

FIG. 41 is a partially exploded perspective view of the example housing 502. In some examples, the housing 502 is similar in many aspects to the housing 102. In some examples, the housing includes a top panel 508, a front panel 510, a right panel 512, a left panel 514, a rear panel 516, and a bottom panel 518. In some examples, the housing 502 further includes a first intermediate panel 515a, a second intermediate panel 515b, and a third intermediate panel 515c. In some examples, the housing further includes a PCB backing panel 720 (not pictured).

In some examples, while orientational references “top,” “bottom,” “front,” “rear,” “left” and “right” are used to refer to different sides of the battery module assembly 500, the battery module assembly 100, and other components herein, the orientation of various components may change as the battery module assembly 500 and battery module assembly 10 are installed within the energy storage systems 10, 20. For example, the battery module assembly 500 need not be installed such that the front panel 510 of the housing 502 faces the front surface of the energy storage system 20. Rather, in some examples, the battery module assembly is installed within the energy storage system 20 such that the top panel 508 of the housing faces the front of the energy storage system 20. Similarly, in some examples, the top panel 508 of the housing faces the rear of the energy storage system 20.

In some examples, the first intermediate panel 515a, second intermediate panel 515b, and third intermediate panel 515c are arranged within the housing 502 parallel to each of the rear panel 516 and front panel 510. In some examples, the first intermediate panel 515a, second intermediate panel 515b, and third intermediate panel 515c are arranged within the housing 502 between each of the rear panel 516 and front panel 510. The second intermediate panel 515b is arranged within the housing 502 between the first intermediate panel 515a and the third intermediate panel 515c.

In some examples, the example housing 502 further includes one or more fasteners 522 that extend therethrough. In some examples, the fasteners 522 interface with the other components of the housing 502 in a manner that is similar in many aspects to the fasteners 122 and the housing 102. In some examples, the fasteners 522 further extend through the first intermediate panel 515a, the second intermediate panel 515b, and the third intermediate panel 515c. In some examples, tightening the fasteners 522 causes the front panel 510, first intermediate panel 515a, second intermediate panel 515b, the third intermediate panel 515c, and the rear panel 516 to exhibit a clamping force on the battery portion 504 of the battery module assembly 500.

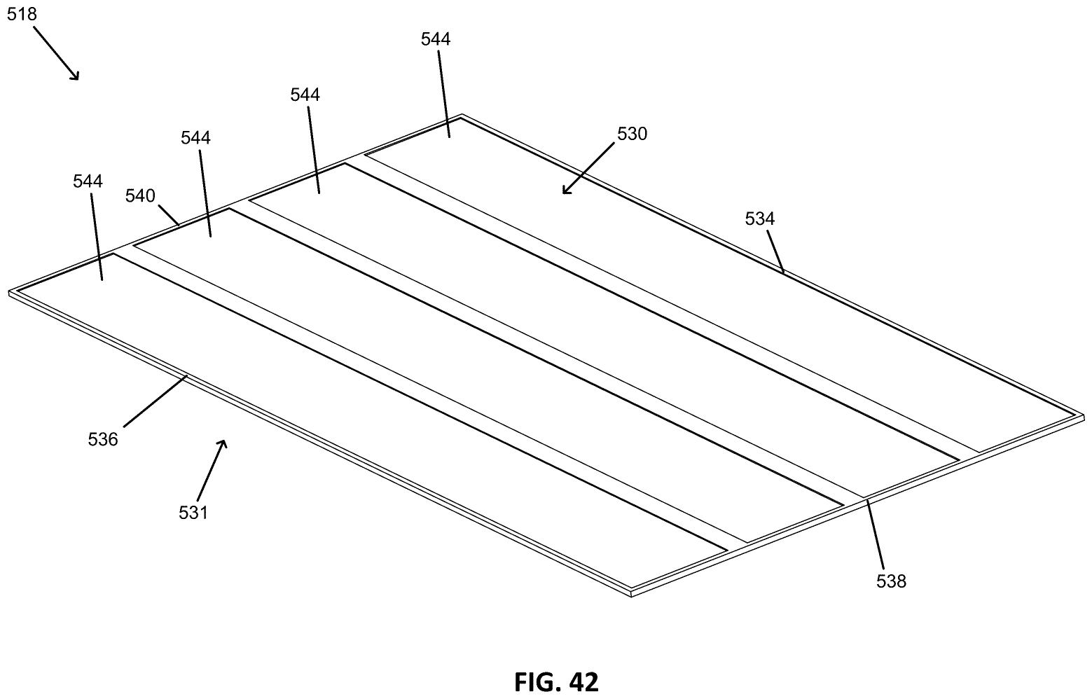

FIG. 42 is a top perspective view of the example bottom panel 518. The bottom panel 518 includes a top surface 530, a bottom surface 531, a front side 534, a rear side 536, a right side 538, a left side 540, and a plurality of recesses 544.

In some examples, each of the recesses 544 extend from the left side 540 to the right side 538 of the bottom panel 518. In some examples, the plurality of recesses are spaced apart from each other between the front side 534 and the rear side 536 of the bottom panel 518 and are arranged linearly between the front side 534 and the rear side 536 of the bottom panel 518.

In some examples, the intermediate panels 515 are arranged on top of the bottom panel 518 on the regions of the top surface 530 between the recesses 544. In some examples, a thermal sheet may be arranged in each of the recesses of the bottom panel 518. In some examples, the thermal sheet is a film heater.

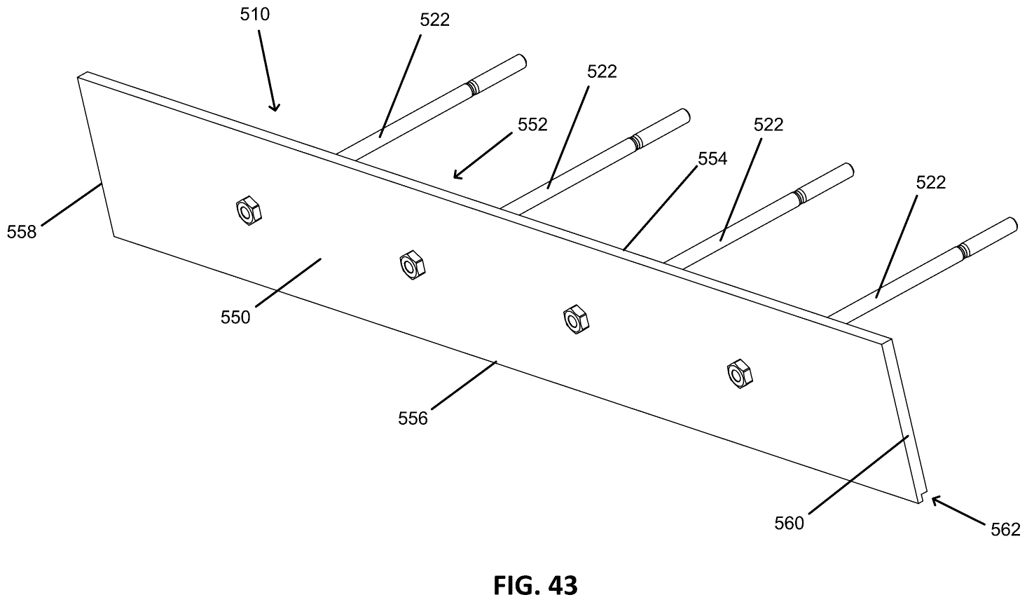

FIG. 43 is front perspective view of the front panel 510 with fasteners 522 extending therethrough. In some examples, the front panel 510 includes an outer surface 550, an inner surface 552, a top side 554, a bottom side 556, a right side 558, a left side 560 and a notch 562. In some examples, the rear panel 516 is similar in many aspects to the front panel 510. In some examples, the front panel 510 is similar in many aspects to the front panel 110.

In some examples, the fasteners 522 extend through holes machined through the outer surface 550 and the inner surface 552 of the front panel 510. In other examples, the fasteners are formed as female fasteners with the front panel 510. In some examples, the fasteners 522 include tapped holes into which the male portions of fasteners extending through the rear panel 516 and engage with. In some examples, the male-female arrangement of fasteners 522 is flipped, such that the male portions extend through the front panel 110 and the female portions extend through the rear panel 116.

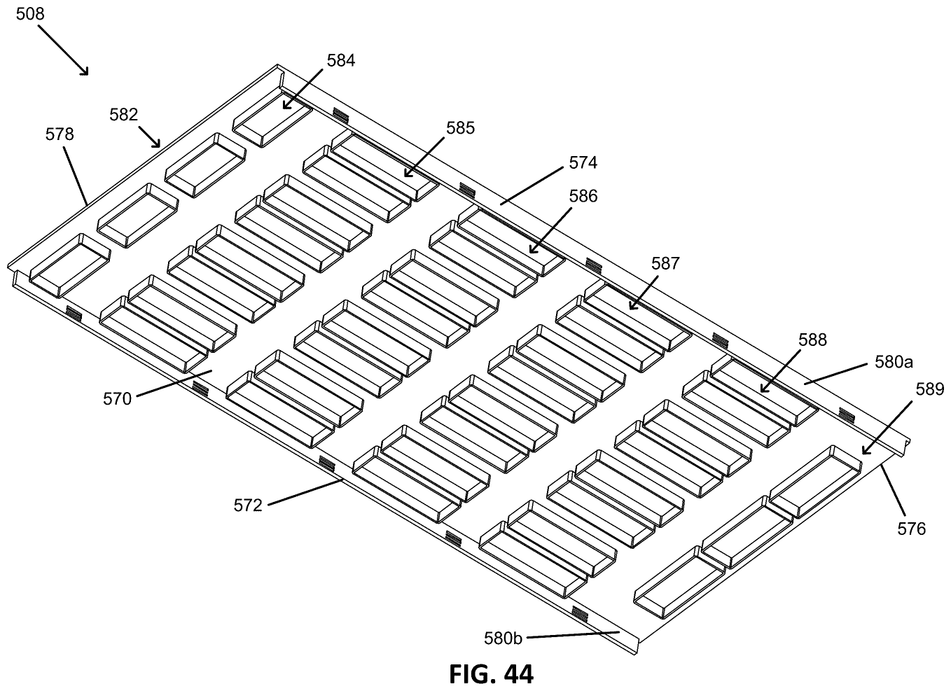

FIG. 44 is a bottom perspective view of the top panel 508. In some examples, the top panel 508 is similar in many aspects to the top panel 108.

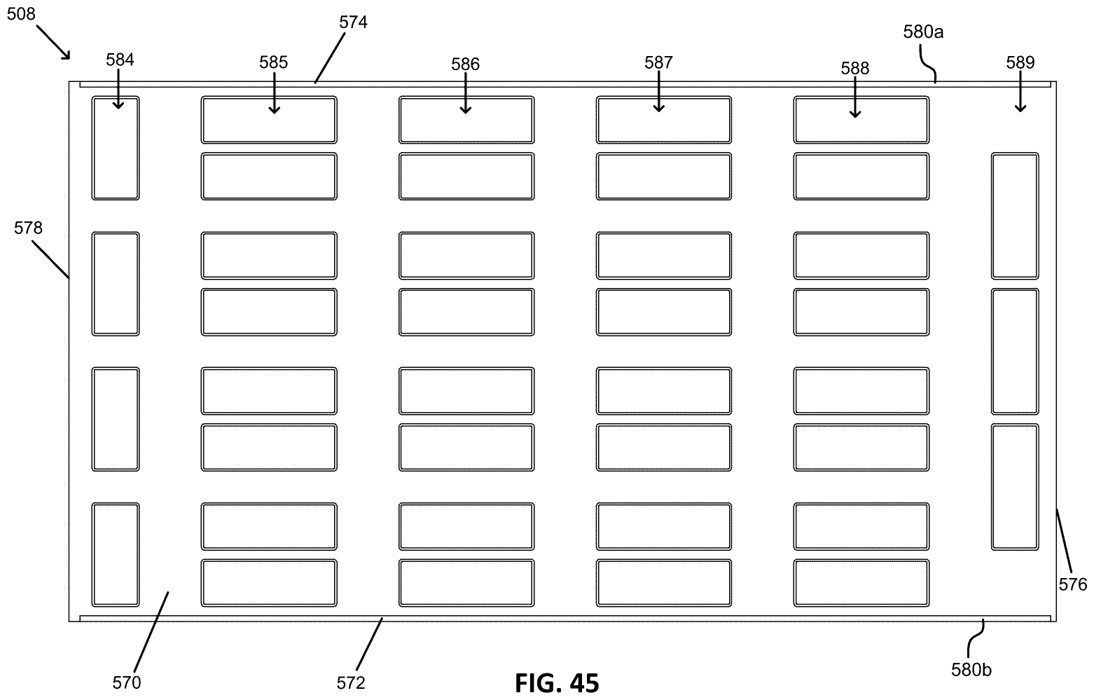

FIG. 45 is a bottom perspective view of the top panel 508. In some examples, the top panel 508 includes a bottom surface 570, a front surface 572, a rear surface 574, a right surface 576, a left surface 578, one or more outer flanges 580, and one or more inner flanges 582.

In some examples, the outer flange 580 extends along perimeter of the top panel 508 along the front surface 572 and rear surface 574. In some examples, the outer flange 580 includes a front outer flange 580a and a rear outer flange 580b. In some examples, the outer flange 580 extends down from the bottom surface 570 of the top panel 508.

In some examples, the one or more inner flanges 582 include a first flange row 584, a second flange row 585, a third flange row 586, a fourth flange row 587, a fifth flange row 588 and a sixth flange row 589, each of which extend downward from the bottom surface 570 of the panel. In some examples, each of the flange rows 584, 585, 586, 587, 588, 589 include a plurality of rectangular flanges that are spaced apart from one another and extend along the bottom surface 570 of the top panel 508 between the front surface 572 and the rear surface 574. Each of the rectangular flanges comprise a length and a width, with the length being the longer side of the rectangle and the width being the shorter side of the rectangle.

In some examples, the first flange row 584 is arranged on the bottom surface 570 closest to the left surface 578 of the top panel 508. Each of the rectangular flanges in the first flange row 584 are oriented such that the length of the rectangle extends between the front surface 572 and the rear surface 574. Each of the rectangular flanges in the first flange row 584 are spaced equidistant from each other. In some examples, the first flange row 584 comprises four rectangular flanges.

In some examples, the second flange row 585, third flange row 586, fourth flange row 587, and fifth flange row 588 are similar in many aspects. In some examples, each of the flange rows 585, 586, 587, 588 contain twice as many rectangular flanges as the first flange row 584. Each of the rectangular flanges in the flange rows 585, 586, 587, 588 are oriented such that the width of the rectangle extends between the front surface 572 and the rear surface 574. In some examples, the rectangular flanges in the flange rows 585, 586, 587, 588 are arranged in pairs, with each rectangular flange of each pair being spaced apart from the other flange in each pair by a first distance. In some examples, each pair is spaced apart from each other pair by a second distance. In some examples, the second distance is greater than the first distance.

The sixth flange row 589 is arranged on the bottom surface 570 closest to the right surface 576 of the top panel 508. Each of the rectangular flanges in the sixth flange row 589 are oriented such that the length of the rectangle extends between the front surface 572 and the rear surface 574. Each of the rectangular flanges in the first flange row 584 are spaced equidistant from each other. In some examples, the sixth flange row 589 contains one rectangular flange less than the first flange row 584.

In some examples, the second flange row 585, third flange row 586, fourth flange row 587, and fifth flange row 588 are each arranged between the first flange row 584 and the sixth flange row 589. In some examples, each of the flange rows 584, 586, 587, 588, 589 are spaced apart from each other by the same distance.

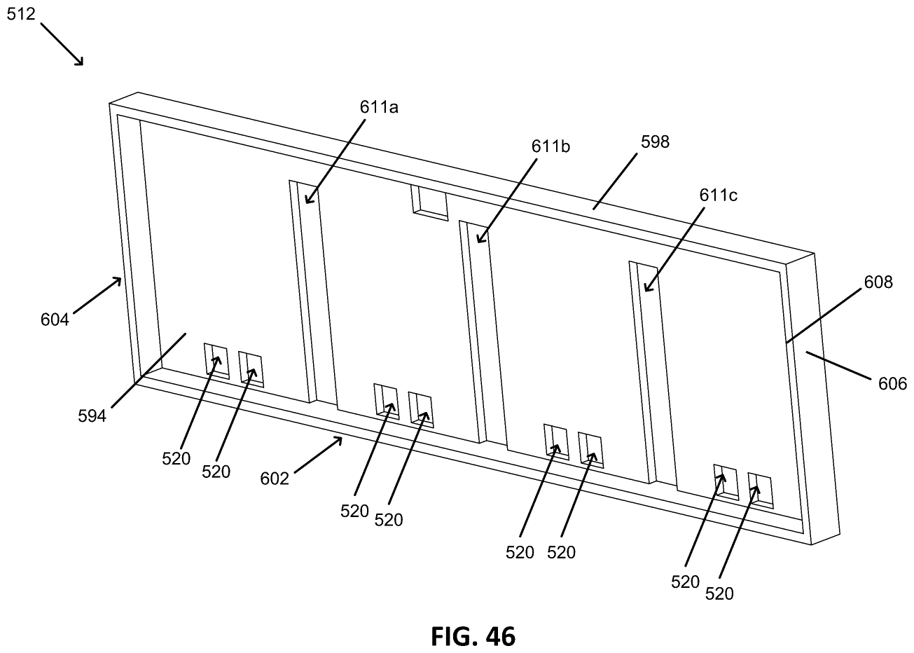

FIG. 46 is a left perspective view of the example right panel 512. In the example of FIG. 46, the right panel 512 includes one or more openings 520, an inner surface 594, an outer surface 596, a top side 598, a bottom side 602, a front side 604, a rear side 606, an outer flange 608, and one or more slots 611.

In some examples, the openings 520 allow access to the interior of the housing 502. In some examples, the openings 520 extend through the inner surface 594 and the outer surface 596 of the right panel 512.

In some examples, outer flange 608 extends from the inner surface 594 of the right panel 512. In some examples, the outer flange 608 extends along the front side 604, the bottom side 602, the rear side 606 and the top side 598.

In some examples, the slots 611 include a first slot 611a, a second slot 611b, and a third slot 611c. In some examples, the slots 611 extend between the bottom side 602 and the top side 598 and are spaced apart from each other between the front side 204 and the rear side 206 of the right panel 512.

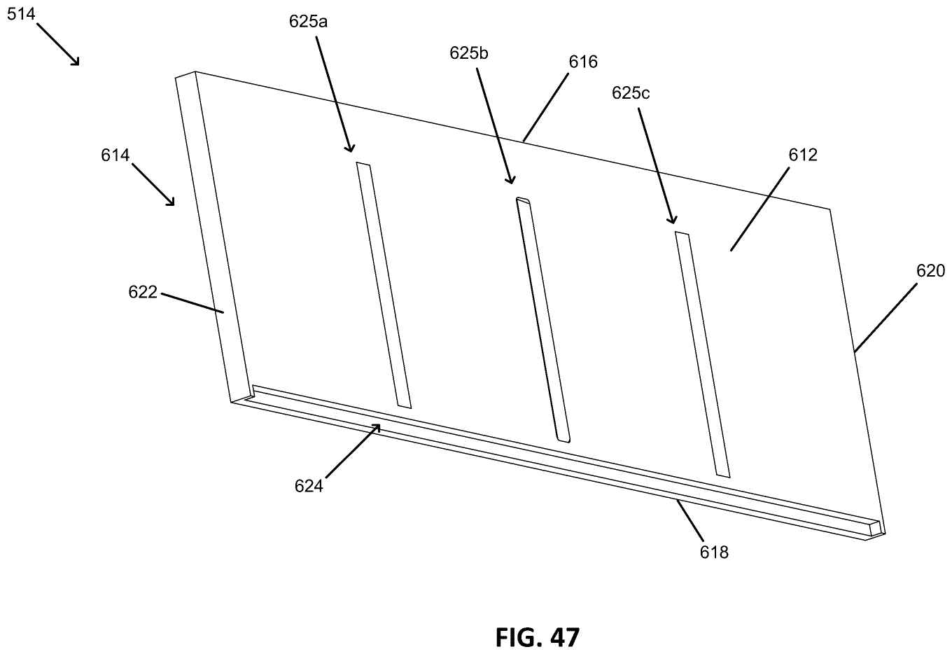

FIG. 47 is a right perspective view of the left panel 514. In some examples, the left panel 514 includes an inner surface 612, an outer surface 614, a top side 616, a bottom side 618, a front side 620, a rear side 622, a lower notch 624, and one or more slots 625.

In the example of FIG. 47 the lower notch 624 extends through the edge of the left panel 514 between the inner surface 612 and the bottom side 618. In some examples, the slots 625 are arranged on the left panel 514 in a substantially similar manner to the way in which the slots 611 are arranged on the right panel 512.

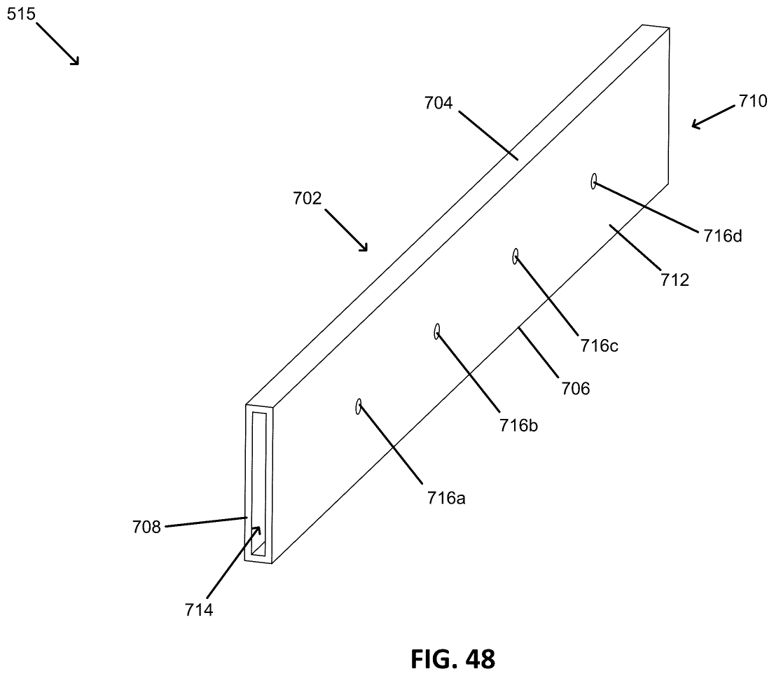

FIG. 48 is a top perspective view of an example intermediate panel 515. In some example, the intermediate panel comprises a front surface 702, a rear surface 712, a top side 704, a bottom side 706, a left side 708, a right side 710, an central opening 714, and one or more holes 716.

In some examples, the central opening 714 extends through the intermediate panel 515 from the left side 708 to the right side 710. In some examples, the intermediate panel 515 includes four holes 716a, 716b, 716c, 716d. In some examples, each of the holes extend through the intermediate panel 515 from the front surface 702 to the rear surface 712. In some examples, the holes 716 are spaced apart from each other between the left side 708 and the right side 710 of the intermediate panel 515.

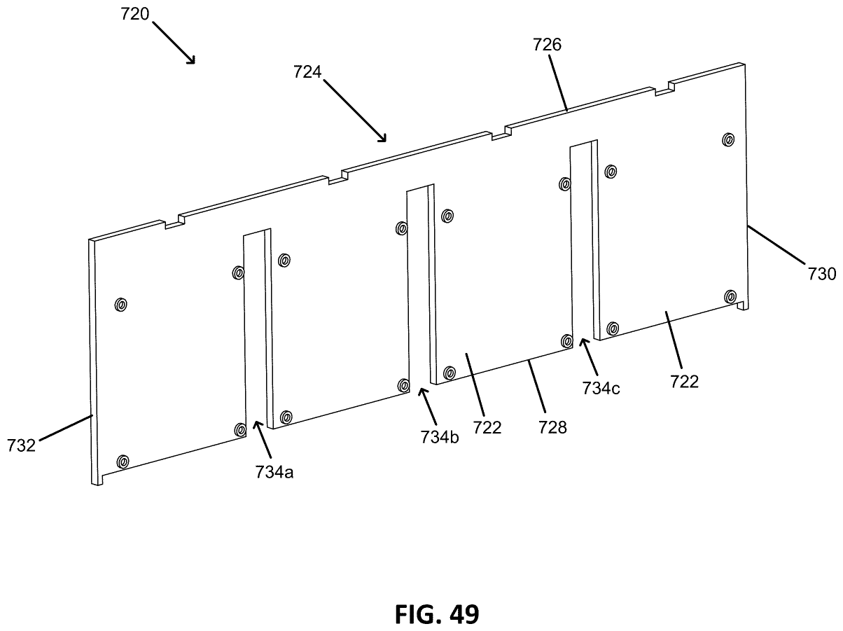

FIG. 49 is a perspective view of an example PCB backing panel 720. In some examples, the PCB backing panel 720 includes a right surface 722, a left surface 724, a top side 726, a bottom side 728, a front side 730, a rear side 732, and one or more notches 734. In some examples, the notches 734 extend through the bottom side 728, right surface 722, and left surface 724. In some examples, the notches are spaced apart from each other between the front side 730 and the rear side 732 of the PCB backing panel 720. In some examples, the PCB backing panel 720 comprises three notches 734.

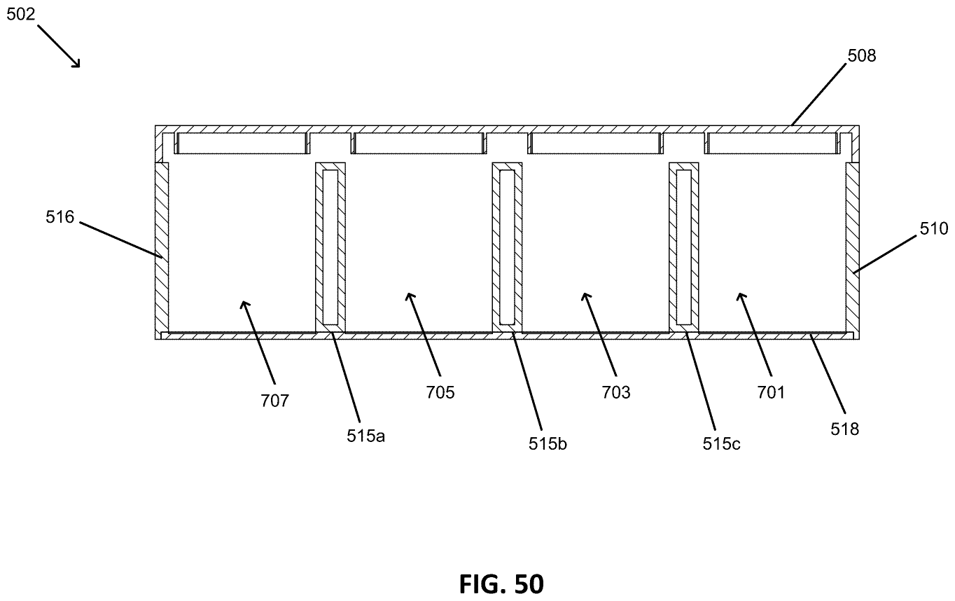

FIG. 50 is a right section view of the example housing 502. As shown in FIG. 49, the top panel is arranged above the front panel 510 and the rear panel 516. Each of the front panel 510 and the rear panel 516 are arranged above the bottom panel 518. In some examples, the front surface 572 and the rear surface 574 of the top panel 508 contact to top sides of the front panel 510 and the rear panel 516. In some examples, the bottom panel 518 fits with in the notches 562 of the front panel 510 and the rear panel 516.

Each of the intermediate panels 515a, 515b, 515c are arranged the housing 502 above the bottom panel 518 and below the top panel 508. In some examples, the housing 502 comprises a plurality of open regions 517a, 517b, 517c, 517d.

In some examples, a first open region 701 is defined by the top panel 508, the front panel 510, the bottom panel 518 the intermediate panel 515c, the left panel 514, and the right panel 516. A second open region 703 is defined by the top panel 508, the bottom panel 518, the intermediate panel 515c, the intermediate panel 515b, the left panel 514, and the right panel 516. A third open region 705 is defined by the top panel 508, the bottom panel 518, the intermediate panel 515b, the intermediate panel 515a, the left panel 514, and the right panel 516. A fourth open region 707 is defined by the top panel 508, the bottom panel 518, the intermediate panel 515a, the rear panel 516, the left panel 514, and the right panel 516. In some examples, each of the open regions 701, 703, 705, 707 include a rectangular flange of the first flange row 584, a pair of rectangular flanges from the second flange row 585, a pair of rectangular flanges from the third flange row 586, a pair of rectangular flanges from the fourth flange row 587, and a pair of rectangular flanges from the fifth flange row 588. In some examples, one of the rectangular flanges of the sixth flange row 589 extends between the first open region 701 and the second open region 703. One of the rectangular flanges of the sixth flange row 589 extends between the second open region 703 and the third open region 705. One of the rectangular flanges of the sixth flange row 589 extends between the third open region 705 and the fourth open region 707.

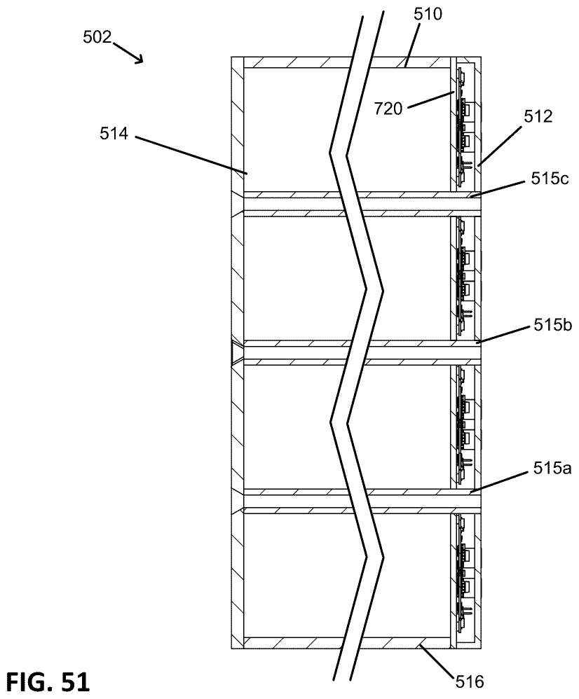

FIG. 51 is a top sectional view of the housing 502. As shown in FIG. 50, the front panel 510 and the rear panel 516 extend between the left panel 514 and the right panel 512. In some examples, the PCB backing panel 720 is arranged between the front panel 510 and the right panel 512 and between the rear panel 516 and the right panel 512. In some examples the intermediate panels 515a, 515b, 515c extend from the inner surface of the left panel 514 through the right panel 512. In some examples, the left side 708 of the intermediate panels 515a, 515b, 515c abut the inner surface of the left panel 514. In some examples, the central opening 714 of the intermediate panels 515a, 515b, 515c is aligned with the slots 625a, 625b, 625c of the left panel. In some examples the slots 625a, 625b, 625c are chamfered such that the openings of the slots 625a, 625b, 625c are larger at the outer surface of the left panel 514 than they are at the inner surface 612 of the left panel.

In some examples, the intermediate panels 515a, 515b, 515c, extend through the notches 734 in the PCB backing panel 720 and the slots 611 in the right panel 512.

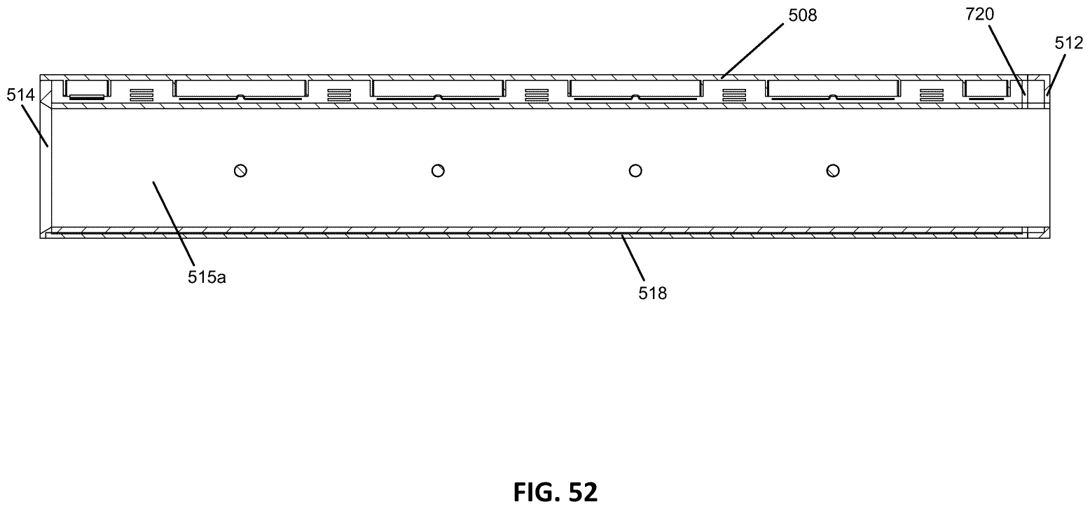

FIG. 52 is a rear section view of the housing 502. As shown in FIG. 52, the intermediate panel 515 extends through the PCB backing panel 720 and the right panel 512. The bottom panel 518 is arranged below the intermediate panel 515 and the PCB backing panel 720 but abuts the inner surfaces 594, 612 of the left panel 514 and the right panel 512. The top panel extends over the intermediate panel 515, the PCB backing panel 720, and the left panel 514 but abuts the right panel 512.

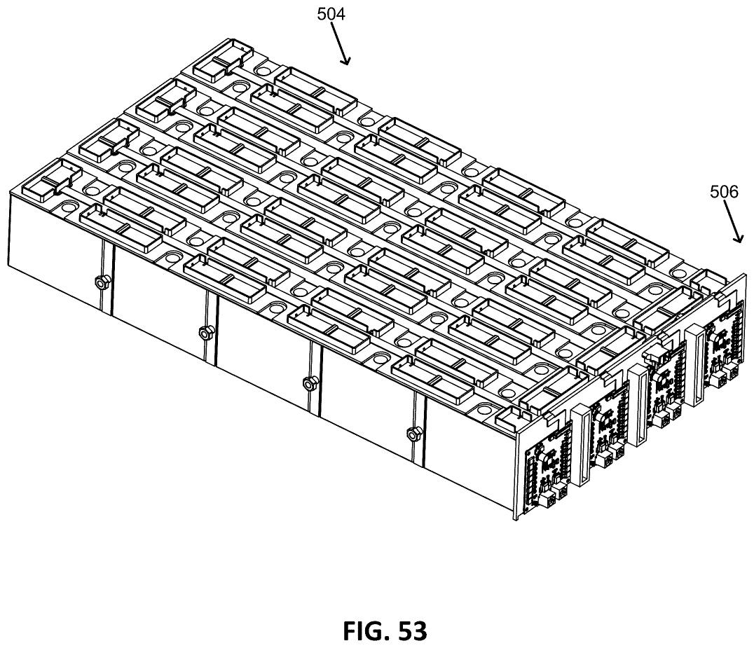

FIG. 53 is a perspective view of the battery portion 504 and the control portion 506 of the example battery module assembly 500. In some examples, the arrangement of the battery portion 504 with respect to the control portion 506 is similar in many aspects to the arrangement of the battery portion 104 with respect to the control portion 106.

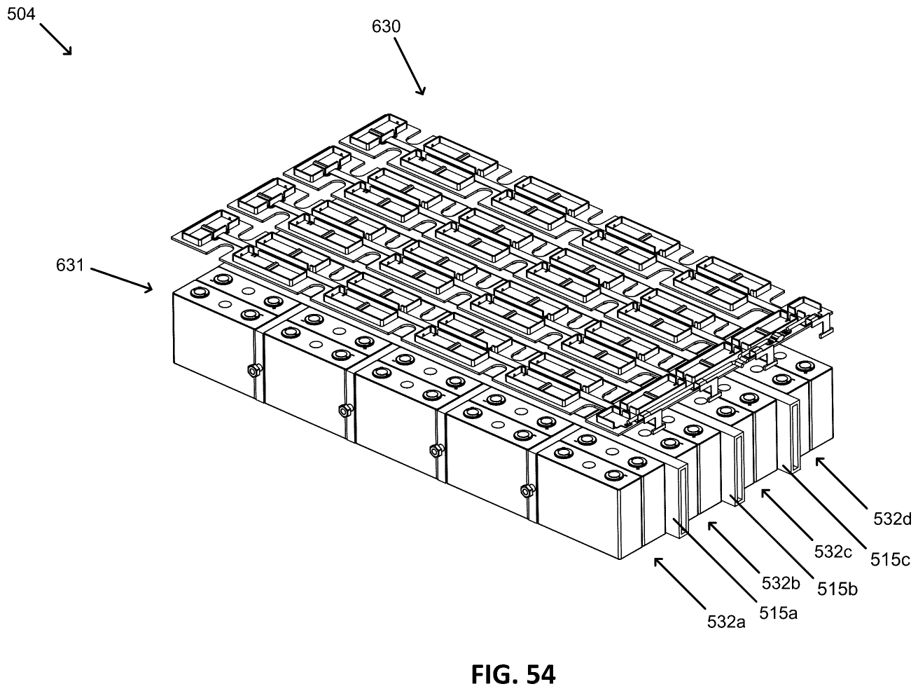

FIG. 54 is an exploded perspective view of the battery portion 504 with the intermediate panels 515 arranged therein. In some examples, the battery portion 504 includes a bus assembly 630 and a battery grid 631.

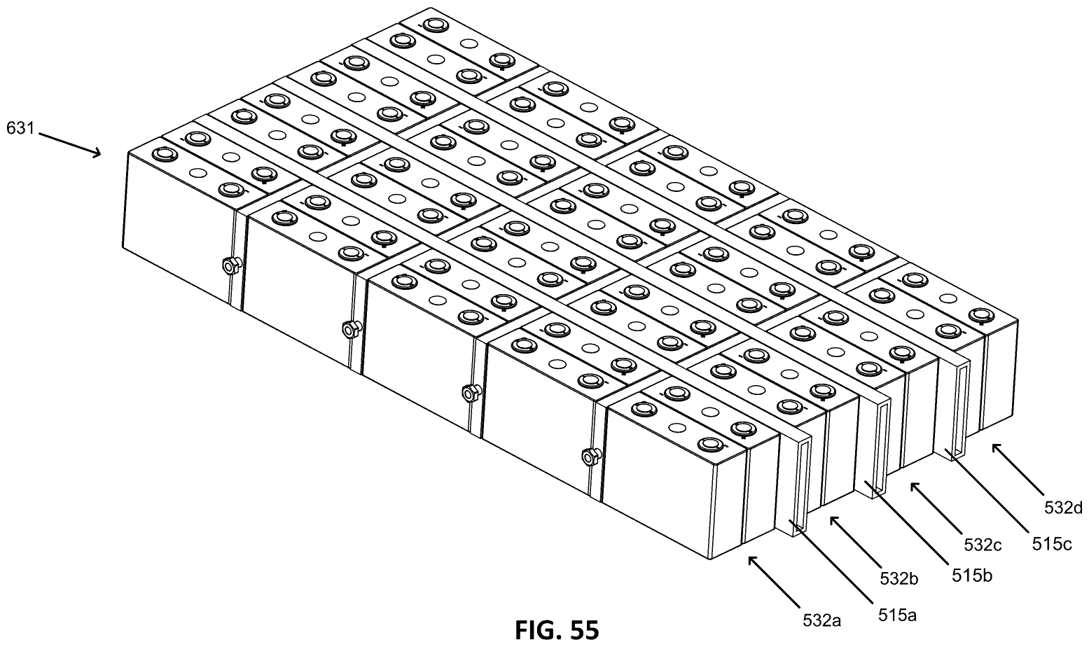

FIG. 55 is a perspective view of the battery grid 631 and the intermediate panels 515. In some examples, the battery grid 631 comprises a plurality of battery packs 532. In some examples, the battery grid 631 comprises four battery packs 532. In some examples, the battery packs 532 are similar in many aspects to the battery pack 232. In some examples, the battery packs 532 differ from the battery pack 232 in that the battery packs 532 each comprise a fourth barrier and a fifth battery stack. In some examples, the fifth battery stack and the fourth barrier arranged with respect to the fourth battery stack in a substantially similar manner as the fourth battery stack 234d and the third barrier 236c are arranged with respect to the third battery stack 234c.

In some examples, the battery packs 532 are separated from each other by the intermediate panels 515. In some examples, a first battery pack 532a is separated from a second battery pack 532b by the first intermediate panel 515a, the second battery pack 532b is separated from a third battery pack 532c by the second intermediate panel 515b, the third battery pack 532c is separated from a fourth battery pack 532d by the third intermediate panel 515c.

In some examples, the battery packs 532 are arranged within the housing 502 in a manner that is similar in many aspects to the manner in which the battery pack 232 is arranged within the housing 102.

In some examples, the battery packs 532 are arranged within the housing such that the front surfaces or the rear surfaces of the battery cells within the battery packs contact the intermediate panels 515 within the housing 502.

In some examples, by arranging the battery packs 532 within the housing 502 in this manner, the housing can facilitate cooling of the battery packs 532 contained therein. Specifically, cool air can be routed around the housing 502 such that the battery packs 532 can be cooled through the top panel 508, the front panel 510, the right panel 512, the left panel 514, the rear panel 516, and the bottom panel 518. Additionally, cool air can be routed through the central opening 714 within the intermediate panels 515 such that the battery packs also can be cooled through the intermediate panels 515.

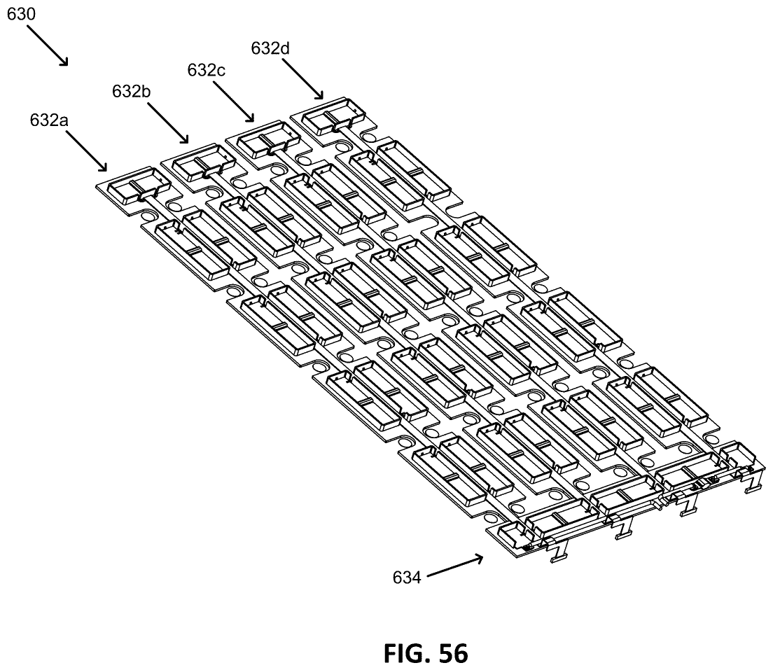

FIG. 56 is a perspective view of the major bus assembly 630. In some examples, the major bus assembly 630 includes a plurality of minor bus assemblies 632a, 632b, 632c, 632d. In some examples, the major bus assembly 630 includes four minor bus assemblies. In some examples, each of the minor bus assemblies 632 are similar in many aspects to the bus assembly 230. In some examples, each of the minor bus assemblies 632 further comprise a fourth bus contact holder pair, fourth bus contact pair and additional row of respective vent cutouts.

In some examples, the major bus assembly 630 further comprises a major bus assembly connector row 634 the major bus assembly connector row 634 extends between each of the minor bus assemblies 632 along an end of the major bus assembly 630 adjacent the control portion 506 and connects each of the minor bus assemblies 632. In some examples, the major bus assembly connector row 634 comprises additional bus contacts.

In some examples, the battery module assembly 500 functions to aid in isolating emitted gasses from the battery cells of the battery module assembly 500 in a similar manner to the battery module assembly 100 described with respect to FIG. 31.

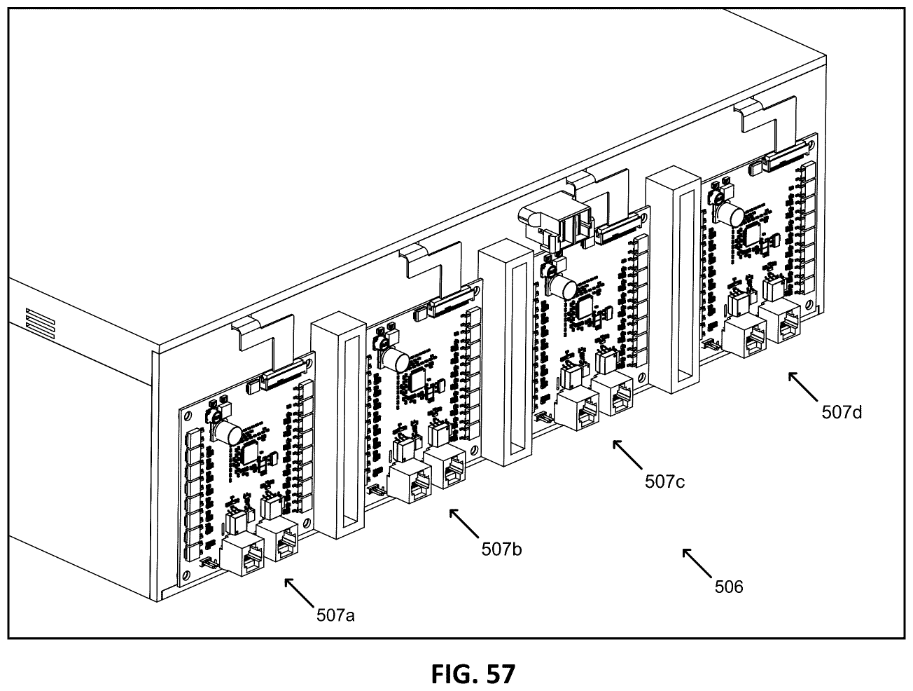

FIG. 57 is a perspective view of the control portion 506 of the battery module assembly 500 with the right panel 512 removed. In some examples, the control portion 506 comprises a plurality of control sub-portions 507. In some examples, each of the control sub-portions 507 are configured to be similar in many aspects to the control portion 106. In some examples, each of the control sub-portions 507 comprise a control board and one or more connectors. In some examples, the number of control sub-portions is equal to the number of battery packs 532 contained within the battery module assembly 500.

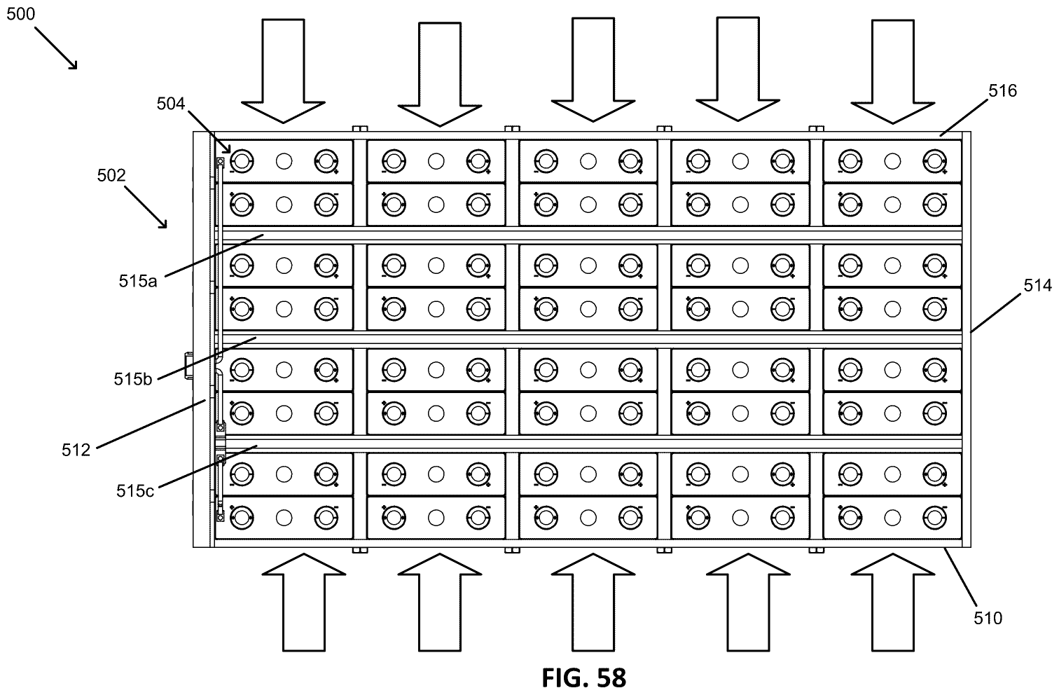

FIG. 58 is a top view of portions of the battery module assembly illustrating the compression profile of the battery portion 504 by the housing 502.

As shown in FIG. 58, the battery cells are arranged in the layout previously described with respect to FIGS. 53-55. When arranged in this configuration, the rear panel 516 of the housing 502 contacts the front surface of the first battery cell of each of the battery stacks in the first battery pack 532a and the first intermediate panel 515a contacts the rear surface of the second battery cell of each of the battery stacks in the first battery pack 532a. The first intermediate panel 515a of the housing 502 contacts the front surface of the first battery cell of each of the battery stacks in the second battery pack 532b and the second intermediate panel 515b contacts the rear surface of the second battery cell of each of the battery stacks in the second battery pack 532b. The second intermediate panel 515b of the housing 502 contacts the front surface of the first battery cell of each of the battery stacks in the third battery pack 532c and the third intermediate panel 515c contacts the rear surface of the second battery cell of each of the battery stacks in the third battery pack 532c. The third intermediate panel 515c of the housing 502 contacts the front surface of the first battery cell of each of the battery stacks in the fourth battery pack 532d and the front panel 510 contacts the rear surface of the second battery cell of each of the battery stacks in the fourth battery pack 532d.

In some examples, the housing 502 is configured such that the front panel 510 and the rear panel 516 are drawn together by tightening the fasteners 522 that extend through each of the front panel 510, the rear panel 516, and the intermediate panels 515. As the fasteners are tightened and the front panel 510 and rear panel 516 are drawn together, the front panel 510 and the rear panel 516 exert a compressive force on each of the battery packs 532a, 532b, 532c, 532d, as illustrated by arrows. In some examples, the intermediate panels 515 are permitted to move within the housing 502 such that the compressive forces exerted by the front panel 510 and rear panel 516 are transmitted through the intermediate panels 515 to the battery packs 532b, 532c.

This disclosure should be understood to include (as illustrative and not limiting) the subject matter set forth in the following numbered clauses:

Clause 1. A battery module assembly comprising:
a first battery stack comprising:
   a first battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
   a first battery stack second battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface;
   the front surface of the first battery stack first battery cell being arranged parallel to the front surface of the first battery stack second battery cell, the top surface of the first battery stack first battery cell being arranged coplanar with the top surface of the first battery stack second battery cell, and the side surface of the first battery stack first battery cell being arranged coplanar with the side surface of the first battery stack second battery cell; and
a barrier having a first surface and a second surface, the first surface of the barrier being arranged parallel and adjacent to the side surface of the first battery stack first battery cell and the side surface of the first battery pack second battery cell.

Clause 2. The battery module assembly of any of the preceding clauses, further comprising a first pair of terminals formed in the top surface of the first battery stack first battery cell and a second pair of terminals formed in the top surface of the first battery stack second battery cell.

Clause 3. The battery module assembly of any of the preceding clauses, further comprising:
a second battery stack comprising:
   a second battery stack first battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface; and
   a second battery stack second battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface;
   the front surface of the second battery stack first battery cell being arranged parallel to the front surface of the second battery stack second battery cell, the top surface of the second battery stack first battery cell being arranged coplanar with the top surface of the second battery stack second battery cell, and the side surface of the second battery stack first battery cell being arranged coplanar with the side surface of the second battery stack second battery cell; and
   the front surface of the second battery stack first battery cell being arranged coplanar to the front surface of the first battery stack first battery cell.

Clause 4. The battery module assembly of any of the preceding clauses, wherein the first battery stack further comprises:
a first battery stack third battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface;
the front surface of the first battery stack third battery cell being arranged parallel to the front surface of the first battery stack second battery cell, the top surface of the first battery stack third battery cell being arranged coplanar with the top surface of the first battery stack second battery cell, and the side surface of the first battery stack third battery cell being arranged coplanar with the side surface of the first battery stack second battery cell.

Clause 5. The battery module assembly of any of the preceding clauses, wherein the first battery stack further comprises:
a first battery stack fourth battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface;
the front surface of the first battery stack fourth battery cell being arranged parallel to the front surface of the first battery stack third battery cell, the top surface of the first battery stack fourth battery cell being arranged coplanar with the top surface of the first battery stack third battery cell, and the side surface of the first battery stack fourth battery cell being arranged coplanar with the side surface of the first battery stack third battery cell.

Clause 6. The battery module assembly of any of the preceding clauses, further comprising a heating film arranged between the first battery stack first battery cell and the first battery stack second battery cell.

Clause 7. The battery module assembly of any of the preceding clauses, wherein the barrier is arranged between the first battery stack and the second battery stack and comprises an electrical insulating material.

Clause 8. The battery module assembly of any of the preceding clauses, further comprising:
a housing having a first panel and a second panel, the first panel being arranged adjacent to the front surface of the first battery stack first battery cell, the second panel being arranged adjacent to a rear surface of the first battery stack second battery cell, the rear surface of the first battery stack second battery cell being arranged parallel to the front surface of the second battery stack second battery cell;
wherein the barrier is arranged between the first panel and the second panel.

Clause 9. The battery module assembly of any of the preceding clauses, wherein the second surface of the barrier is arranged parallel and adjacent to the side surface of the second battery stack first battery cell and the side surface of the second battery pack second battery cell.

Clause 10. The battery module assembly of any of the preceding clauses, wherein the barrier is configured to mitigate thermal runaway.

Clause 11. The battery module assembly of any of the preceding clauses, wherein the barrier is not compressed.

Clause 12. The battery module assembly of any of the preceding clauses, further comprising:
a third battery stack comprising:
   a third battery stack first battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface; and
   a third battery stack second battery cell having a front surface, a side surface, and a top surface, each of the front surface, side surface, and the top surface being perpendicularly arranged with respect to each other, the surface area of the front surface being greater than the surface area of the side surface, and the surface area of the front surface being greater than the surface area of the top surface;
   the front surface of the third battery stack first battery cell being arranged parallel to the front surface of the third battery stack second battery cell, the top surface of the third battery stack first battery cell being arranged coplanar with the top surface of the third battery stack second battery cell, and the side surface of the third battery stack first battery cell being arranged coplanar with the side surface of the third battery stack second battery cell; and
   the front surface of the third battery stack first battery cell being arranged coplanar to the front surface of the second battery stack first battery cell.

Clause 13. The battery module assembly of any of the preceding clauses, further comprising a second barrier having a first surface and a second surface, the second surface of the second barrier being arranged parallel and adjacent to the side surface of the third battery stack first battery cell and the side surface of the third battery stack second battery cell, the second barrier being arranged between the second battery stack and the third battery stack.

Clause 14. The battery module assembly of any of the preceding clauses, further comprising a housing having a first panel and a second panel, the first panel being arranged adjacent to the front surface of the first battery stack first battery cell, the second panel being arranged adjacent to a rear surface of the first battery stack second battery cell, the rear surface of the first battery stack second battery cell being arranged parallel to the front surface of the first battery stack second battery cell.

Clause 15. The battery module assembly of any of the preceding clauses, where the barrier is arranged between the first panel and the second panel.

Clause 16. The battery module assembly of any of the preceding clauses,
wherein the first panel is configured to be drawn towards the second panel; and
wherein the first panel contacts the front surface of the first battery stack first battery cell and the second panel contacts the rear surface of the first battery stack second battery cell as the first panel is drawn towards the second panel.

17. The battery module assembly of any of the preceding clauses, wherein the first panel is connected to the second panel by one or more fasteners.

Clause 18. The battery module assembly of any of the preceding clauses, wherein the one or more fasteners are configured to draw the first panel towards the second panel as the one or more fasteners are tightened.

Clause 19. The battery module assembly of any of the preceding clauses, wherein the first panel and the second panel exhibit a clamping force as the first panel is drawn towards the second panel, the clamping force being controlled by applying a specified torque to each of the one or more fasteners.

Clause 20. The battery module assembly of any of the preceding clauses, wherein at least one of the one or more fasteners extends through the barrier.

Clause 21. The battery module assembly of any of the preceding clauses, wherein the first panel contacts the front surface of the first battery stack first battery cell and the second panel contacts the rear surface of the first battery stack second battery cell as the one or more fasteners draw the first panel towards the second panel.

Clause 22. The battery module assembly of any of the preceding clauses, further comprising a bus assembly.

Clause 23. The battery module assembly of any of the preceding clauses, wherein the bus assembly contacts the first pair of terminals and the second pair of terminals.

Clause 24. The battery module assembly of any of the preceding clauses, further comprising a top panel.

Clause 25. The battery module assembly of any of the preceding clauses, wherein the top panel and the bus assembly mate together to isolate one or more electrical components of the battery module assembly.

Clause 26. The battery module assembly of any of the preceding clauses, wherein a top barrier comprising a dielectric material is arranged between the top panel and the bus assembly.

Clause 27. An energy storage system comprising:
a cabinet; and
a battery module assembly housed within the cabinet;
the battery module assembly including a first battery stack comprising a first battery stack first battery cell and a first battery stack second battery cell, the first battery stack first battery cell and the first battery stack second battery cell contacting each other at a first seam, the first seam being arranged in a plane that is parallel to the plane of a front surface of the cabinet.

Clause 28. The energy storage system of any of the preceding clauses, wherein the front surface of the cabinet comprises a door.

Clause 29. The energy storage system of any of the preceding clauses, wherein the battery module assembly further includes a barrier arranged perpendicularly to the plane of the first seam.

Clause 30. The energy storage system of any of the preceding clauses, further comprising a second battery stack comprising a second battery stack first battery cell and a second battery pack second battery cell, wherein the barrier is configured to mitigate thermal runaway propagation in the battery module assembly between the first battery stack and the second battery stack.

Clause 31. The energy storage system of any of the preceding clauses, wherein the barrier comprises a thermally resistive material.

Clause 32. The energy storage system of any of the preceding clauses, wherein the first battery stack first battery cell and the first battery stack second battery cell contact each other at a second seam, the second seam being coplanar with the first seam.

Clause 33. The energy storage system of any of the preceding clauses, wherein the barrier separates the first battery stack from the second battery stack.

Clause 34. The energy storage system of any of the preceding clauses, wherein the barrier is arranged in a plane perpendicular to the plane of the first seam and the second seam.

Clause 35. A battery module assembly comprising:
a first battery stack comprising:
   a first battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
   a first battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
   the front surface of the first battery stack first battery cell being arranged parallel to the front surface of the first battery stack second battery cell, the top surface of the first battery stack first battery cell being arranged coplanar with the top surface of the first battery stack second battery cell, and the side surface of the first battery stack first battery cell being arranged coplanar with the side surface of the first battery stack second battery cell; and
a first barrier having a first surface and a second surface, the first surface of the first barrier being arranged parallel and adjacent to the side surface of the first battery stack first battery cell and the side surface of the first battery stack second battery cell.

Clause 36. The battery module assembly of any of the preceding clauses, further comprising a first pair of terminals formed in the top surface of the first battery stack first battery cell and a second pair of terminals formed in the top surface of the first battery stack second battery cell.

Clause 37. The battery module assembly of any of the preceding clauses, further comprising a housing having a first panel and a second panel, the first panel being arranged adjacent to the front surface of the first battery stack first battery cell, the second panel being arranged adjacent to a rear surface of the first battery stack second battery cell, the rear surface of the first battery stack second battery cell being arranged parallel to the front surface of the first battery stack second battery cell;
wherein the first panel is configured to be drawn towards the second panel; and
wherein the first panel is configured to contact the front surface of the first battery stack first battery cell and the second panel is configured to contact the rear surface of the first battery stack second battery cell as the first panel is drawn towards the second panel.

Clause 38. The battery module assembly of any of the preceding clauses, further comprising:
a second battery stack comprising:
   a second battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
   a second battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
   the front surface of the second battery stack first battery cell being arranged parallel to the front surface of the second battery stack second battery cell, the top surface of the second battery stack first battery cell being arranged coplanar with the top surface of the second battery stack second battery cell, and the side surface of the second battery stack first battery cell being arranged coplanar with the side surface of the second battery stack second battery cell; and
the front surface of the second battery stack first battery cell being arranged coplanar to the front surface of the first battery stack first battery cell.

Clause 39. The battery module assembly of any of the preceding clauses, wherein the first barrier is arranged between the first battery stack and the second battery stack and comprises an electrical insulating material.

Clause 40. The battery module assembly of any of the preceding clauses, further comprising:
a housing having a first panel and a second panel, the first panel being arranged adjacent to the front surface of the first battery stack first battery cell, the second panel being arranged adjacent to a rear surface of the first battery stack second battery cell, the rear surface of the first battery stack second battery cell being arranged parallel to the front surface of the second battery stack second battery cell;
wherein the first barrier is arranged between the first panel and the second panel.

Clause 41. The battery module assembly of any of the preceding clauses, wherein the second surface of the first barrier is arranged parallel and adjacent to the side surface of the second battery stack first battery cell and the side surface of the second battery stack second battery cell.

Clause 42. The battery module assembly of any of the preceding clauses, wherein the first battery stack, the second battery stack, and the first barrier form a first battery pack, and wherein the battery module assembly further comprises an intermediate panel and a second battery pack, the second battery pack comprising:
a third battery stack comprising:
   a third battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
   a third battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
   the front surface of the third battery stack first battery cell being arranged parallel to the front surface of the third battery stack second battery cell, the top surface of the third battery stack first battery cell being arranged coplanar with the top surface of the first battery stack second battery cell, and the side surface of the first battery stack first battery cell being arranged coplanar with the side surface of the first battery stack second battery cell;
a fourth battery stack comprising:
   a fourth battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
   a fourth battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
   the front surface of the fourth battery stack first battery cell being arranged parallel to the front surface of the fourth battery stack second battery cell, the top surface of the fourth battery stack first battery cell being arranged coplanar with the top surface of the fourth battery stack second battery cell, and the side surface of the fourth battery stack first battery cell being arranged coplanar with the side surface of the fourth battery stack second battery cell; and
a second barrier having a first surface and a second surface, the first surface of the second barrier being arranged parallel and adjacent to the side surface of the third battery stack first battery cell and the side surface of the third battery stack second battery cell.

Clause 43. The battery module assembly of any of the preceding clauses, wherein the second surface of the second barrier is arranged parallel and adjacent to the side surface of the fourth battery stack first battery cell and the side surface of the fourth battery stack battery cell; and

Clause 44. The battery module assembly of any of the preceding clauses, wherein the intermediate panel is arranged between the first battery pack and the second battery pack.

Clause 45. The battery module assembly of any of the preceding clauses, wherein the intermediate panel comprises a central opening formed therethrough. Clause 46. An energy storage system comprising:
a cabinet comprising a front surface and a rear surface, the rear surface being configured to be mounted to a wall of a building; and
a battery module assembly housed within the cabinet;
the battery module assembly including:
   a first battery stack comprising a first battery stack first battery cell and a first battery stack second battery cell, the first battery stack first battery cell and the first battery stack second battery cell contacting each other at a first seam; and
   a second battery stack comprising a second battery stack first battery cell and a second battery stack second battery cell, the second battery stack first battery cell and the second battery stack second battery cell contacting each other at a second seam;
   the first seam being arranged in a first seam plane and the second seam being arranged in a second seam plane, the first seam plane and the second seam plane being co-planar with each other.

Clause 47. The energy storage system of any of the preceding clauses, wherein each of the first seam plane and the second seam plane are parallel to the a plane of the rear surface of the cabinet.

Clause 48. The energy storage system of any of the preceding clauses, wherein each of the battery cells comprise top surface that includes a plurality of terminals, the top surface being arranged in a plane that is parallel to a plane of the rear surface of the cabinet.

Clause 49. The energy storage system of any of the preceding clauses, wherein the battery module assembly further comprises:
a housing having a first panel and a second panel,
the first panel contacting a first side of the first battery stack first battery cell and a first side of the first battery stack second battery cell, the first panel being arranged in a first panel plane that is parallel to each of the first seam plane and the second seam plane;
the second panel contacting a second side of the first battery stack first battery cell and a second side of the first battery stack second battery cell, the second panel being arranged in a second panel plane that is parallel to each of the first seam plane and the second seam plane; and
at least one of the first panel and the second panel being movable towards the first seam plane and the second seam plane so as to provide compression to the first battery stack first battery cell and the first battery stack second battery cell.

Clause 50. The energy storage system of any of the preceding clauses, wherein the second panel comprises a central opening formed therethrough.

Clause 51. The energy storage system of any of the preceding clauses, wherein each of the first panel and the second panel comprise a thermally conductive material.

Clause 52. The energy storage system of any of the preceding clauses, wherein the battery module assembly further comprises a first barrier arranged between the first battery stack and the second battery stack, the first barrier comprising a thermally insulating material.

Clause 53. The energy storage system of any of the preceding clauses, wherein the first barrier is arranged in a first barrier plane positioned between the first battery stack and the second battery stack, the first barrier plane being perpendicular to the first seam plane and the second seam plane.

Clause 54. The energy storage system of any of the preceding clauses, further comprising:
a third battery stack comprising a third battery stack first battery cell and a third battery stack second battery cell, the third battery stack first battery cell and the third battery stack second battery cell contacting each other at a third seam; and
a fourth battery stack comprising a fourth battery stack first battery cell and a fourth battery stack second battery cell, the fourth battery stack first battery cell and the fourth battery stack second battery cell contacting each other at a fourth seam.
the third seam being arranged in a third seam plane and the fourth seam being arranged in a fourth seam plane, the third seam plane and the fourth seam plane being arranged coplanar with each other.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A battery module assembly comprising:
a first battery stack comprising:
a first battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
a first battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
the front surface of the first battery stack first battery cell being arranged parallel to the front surface of the first battery stack second battery cell, the top surface of the first battery stack first battery cell being arranged coplanar with the top surface of the first battery stack second battery cell, and the side surface of the first battery stack first battery cell being arranged coplanar with the side surface of the first battery stack second battery cell; and
a first barrier having a first surface and a second surface, the first surface of the first barrier being arranged parallel and adjacent to the side surface of the first battery stack first battery cell and the side surface of the first battery stack second battery cell.

2. The battery module assembly of claim 1, further comprising a first pair of terminals formed in the top surface of the first battery stack first battery cell and a second pair of terminals formed in the top surface of the first battery stack second battery cell.

3. The battery module assembly of claim 1, further comprising a housing having a first panel and a second panel, the first panel being arranged adjacent to the front surface of the first battery stack first battery cell, the second panel being arranged adjacent to a rear surface of the first battery stack second battery cell, the rear surface of the first battery stack second battery cell being arranged parallel to the front surface of the first battery stack second battery cell;
wherein the first panel is configured to be drawn towards the second panel; and
wherein the first panel is configured to contact the front surface of the first battery stack first battery cell and the second panel is configured to contact the rear surface of the first battery stack second battery cell as the first panel is drawn towards the second panel.

4. The battery module assembly of claim 1, further comprising:
a second battery stack comprising:
a second battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
a second battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
the front surface of the second battery stack first battery cell being arranged parallel to the front surface of the second battery stack second battery cell, the top surface of the second battery stack first battery cell being arranged coplanar with the top surface of the second battery stack second battery cell, and the side surface of the second battery stack first battery cell being arranged coplanar with the side surface of the second battery stack second battery cell; and
the front surface of the second battery stack first battery cell being arranged coplanar to the front surface of the first battery stack first battery cell.

5. The battery module assembly of claim 4, wherein the first barrier is arranged between the first battery stack and the second battery stack and comprises an electrical insulating material.

6. The battery module assembly of claim 4, further comprising:
a housing having a first panel and a second panel, the first panel being arranged adjacent to the front surface of the first battery stack first battery cell, the second panel being arranged adjacent to a rear surface of the first battery stack second battery cell, the rear surface of the first battery stack second battery cell being arranged parallel to the front surface of the second battery stack second battery cell;
wherein the first barrier is arranged between the first panel and the second panel.

7. The battery module assembly of claim 4, wherein the second surface of the first barrier is arranged parallel and adjacent to the side surface of the second battery stack first battery cell and the side surface of the second battery stack second battery cell.

8. The battery module assembly of claim 4, wherein the first battery stack, the second battery stack, and the first barrier form a first battery pack, and wherein the battery module assembly further comprises an intermediate panel and a second battery pack, the second battery pack comprising:
a third battery stack comprising:
a third battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
a third battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
the front surface of the third battery stack first battery cell being arranged parallel to the front surface of the third battery stack second battery cell, the top surface of the third battery stack first battery cell being arranged coplanar with the top surface of the first battery stack second battery cell, and the side surface of the first battery stack first battery cell being arranged coplanar with the side surface of the first battery stack second battery cell;
a fourth battery stack comprising:
a fourth battery stack first battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface; and
a fourth battery stack second battery cell having a front surface, a side surface, and a top surface, each of the front surface, the side surface, and the top surface being perpendicularly arranged with respect to each other, the surface area of the front surface being greater than the surface area of the side surface, and the surface area of the front surface being greater than the surface area of the top surface;
the front surface of the fourth battery stack first battery cell being arranged parallel to the front surface of the fourth battery stack second battery cell, the top surface of the fourth battery stack first battery cell being arranged coplanar with the top surface of the fourth battery stack second battery cell, and the side surface of the fourth battery stack first battery cell being arranged coplanar with the side surface of the fourth battery stack second battery cell; and
a second barrier having a first surface and a second surface, the first surface of the second barrier being arranged parallel and adjacent to the side surface of the third battery stack first battery cell and the side surface of the third battery stack second battery cell.

9. The battery module assembly of claim 8, wherein the second surface of the second barrier is arranged parallel and adjacent to the side surface of the fourth battery stack first battery cell and the side surface of the fourth battery stack second battery cell.

10. The battery module assembly of claim 9, wherein the intermediate panel is arranged between the first battery pack and the second battery pack.

11. The battery module assembly of claim 10, wherein the intermediate panel comprises a central opening formed therethrough.

12. An energy storage system comprising:
a cabinet comprising a front surface and a rear surface, the rear surface being configured to be mounted to a wall of a building; and
a battery module assembly housed within the cabinet;
the battery module assembly including:
a first battery stack comprising a first battery stack first battery cell and a first battery stack second battery cell, the first battery stack first battery cell and the first battery stack second battery cell contacting each other at a first seam; and
a second battery stack comprising a second battery stack first battery cell and a second battery stack second battery cell, the second battery stack first battery cell and the second battery stack second battery cell contacting each other at a second seam;
the first seam being arranged in a first seam plane and the second seam being arranged in a second seam plane, the first seam plane and the second seam plane being co-planar with each other.

13. The energy storage system of claim 12, wherein each of the first seam plane and the second seam plane are parallel to the a plane of the rear surface of the cabinet.

14. The energy storage system of claim 12, wherein each of the battery cells comprise top surface that includes a plurality of terminals, the top surface being arranged in a plane that is parallel to a plane of the rear surface of the cabinet.

15. The energy storage system of claim 12, wherein the battery module assembly further comprises:
a housing having a first panel and a second panel,
the first panel contacting a first side of the first battery stack first battery cell and a first side of the first battery stack second battery cell, the first panel being arranged in a first panel plane that is parallel to each of the first seam plane and the second seam plane;
the second panel contacting a second side of the first battery stack first battery cell and a second side of the first battery stack second battery cell, the second panel being arranged in a second panel plane that is parallel to each of the first seam plane and the second seam plane; and
at least one of the first panel and the second panel being movable towards the first seam plane and the second seam plane so as to provide compression to the first battery stack first battery cell and the first battery stack second battery cell.

16. The energy storage system of claim 15, wherein the second panel comprises a central opening formed therethrough.

17. The energy storage system of claim 16, wherein each of the first panel and the second panel comprise a thermally conductive material.

18. The energy storage system of claim 17, wherein the battery module assembly further comprises a first barrier arranged between the first battery stack and the second battery stack, the first barrier comprising a thermally insulating material.

19. The energy storage system of claim 18, wherein the first barrier is arranged in a first barrier plane positioned between the first battery stack and the second battery stack, the first barrier plane being perpendicular to the first seam plane and the second seam plane.

20. The energy storage system of claim 19, further comprising:
a third battery stack comprising a third battery stack first battery cell and a third battery stack second battery cell, the third battery stack first battery cell and the third battery stack second battery cell contacting each other at a third seam; and
a fourth battery stack comprising a fourth battery stack first battery cell and a fourth battery stack second battery cell, the fourth battery stack first battery cell and the fourth battery stack second battery cell contacting each other at a fourth seam;
the third seam being arranged in a third seam plane and the fourth seam being arranged in a fourth seam plane, the third seam plane and the fourth seam plane being arranged coplanar with each other.
